(19) United States
(12) Patent Application Publication
(10) Pub. No.: US 2024/0424800 A1
(43) Pub. Date: Dec. 26, 2024

(54) METHOD OF HEAT WELDING CARTRIDGE AND SHEET

(71) Applicant: SEIKO EPSON CORPORATION, Tokyo (JP)

(72) Inventors: Takumi NAGASHIMA, Matsumoto-shi (JP); Shun Oya, Kiso-machi (JP)

(73) Assignee: SEIKO EPSON CORPORATION, Tokyo (JP)

(21) Appl. No.: 18/750,166

(22) Filed: Jun. 21, 2024

(30) Foreign Application Priority Data
Jun. 23, 2023 (JP) 2023-103176

(51) Int. Cl. B41J 2/175

(52) U.S. Cl. CPC B41J 2/1752; B41J 2/17553; B41J 2/17559

(57) ABSTRACT

A liquid accommodation portion, a liquid supply portion, an accommodation portion including a wall portion, a plurality of welding projection portions, and a plurality of heat welding portions attached to a portion of a surface of the plurality of welding projection portions and disposed in a state of being spaced apart, and a sheet bonded to the plurality of welding projection portions configured to be peeled off, while covering the opening, the plurality of welding projection portions, and the plurality of heat welding portions are provided, in which the plurality of welding projection portions are portions not melted by heat welding among projection portions made of a material configured to be heat-welded, and the plurality of heat welding portions are portions formed by being melted by heat welding among the projection portions before being heat-welded to the sheet, and a portion of which are in contact with the sheet.

The present application is based on, and claims priority from JP Application Serial Number 2023-103176, filed Jun. 23, 2023, the disclosure of which is hereby incorporated by reference herein in its entirety.

### BACKGROUND

### 1. Technical Field

The present disclosure relates to a method of heat welding a cartridge and a sheet.

### 2. Related Art

JP-A-2022-148023 discloses a cartridge including a film disposed on an adapter. The adapter is attached to a liquid accommodation body that accommodates ink. A liquid supply portion, which is a cylindrical member projecting from the liquid accommodation body, is disposed inside the adapter. The adapter is engaged with a printing apparatus when the cartridge is mounted on the printing apparatus.

The liquid supply portion supplies the ink to the outside. An opening portion is formed in a bottom wall of the adapter. The liquid supply portion is disposed such that the central axis of the liquid supply portion passes through the opening portion. The liquid supply portion is provided with a valve mechanism that opens a valve when a liquid introduction portion of the printing apparatus is inserted and closes the valve in a state where the liquid introduction portion is not inserted. When the liquid introduction portion of the printing apparatus is inserted into the liquid supply portion, the ink inside the liquid accommodation body is supplied to the printing apparatus.

The film is attached to a bottom wall in a state of covering the opening portion of the adapter. Specifically, a first attachment portion, which is one projection portion, is formed at the bottom wall of the adapter. The first attachment portion surrounds the opening portion. The film is in a state of covering the first attachment portion and the opening portion. The film is attached to the cartridge by welding the film to the first attachment portion. The film is peeled off from the opening portion by a user before the cartridge is mounted on the printing apparatus.

In general, it is known that in heat welding, a portion heated by welding may be deformed due to melting. In the cartridge of JP-A-2022-148023, by performing heat welding by a welding member in a state where the first attachment portion, which is a projection portion, is covered with a film, it is considered that the wall of the adapter in which a projection portion is not formed is prevented from being recessed by melting. On the other hand, in the cartridge of JP-A-2022-148023, there is a possibility that a portion of the first attachment portion in contact with the film is melted by heat welding due to the welding member, and the melted portion flows into a stepped portion of the first attachment portion. Since direct heat is not applied to the stepped portion by the welding member, the temperature during heat welding is lower than that of the portion of the first attachment portion in contact with the welding member. Therefore, the portion that melts and flows into the stepped portion may be solidified in an unstable state that does not adhere to the stepped portion. There is a possibility that the portion that is solidified in a state of not being adhered to the stepped portion may be peeled off while adhering to the film when the film is peeled off from the adapter by the user.

By adhering to the film, there is a concern that the portion peeled off from the wall enters the opening portion. There is a possibility that the material that entered the opening portion adheres to the liquid supply portion. For the liquid introduction portion of the printing apparatus to be coupled to the liquid supply portion and flow the ink, the liquid introduction portion and the liquid supply portion need to be in close contact with each other. For example, when a linear material along the shape of the first attachment portion is attached to the liquid supply portion via the opening portion, there is a concern that a gap is generated between the liquid introduction portion and the liquid supply portion. As a result, there is a possibility that the ink in the liquid accommodation body leaks from the gap generated between the liquid introduction portion and the liquid supply portion.

### SUMMARY

According to a first aspect of the present disclosure, there is provided a cartridge mounted on a printing apparatus having a liquid introduction portion. The cartridge includes a liquid accommodation portion that accommodates a liquid, a liquid supply portion configured to supply the liquid accommodated in the liquid accommodation portion to the printing apparatus by being coupled to the liquid introduction portion, an accommodation portion that accommodates a portion of the liquid supply portion therein, and includes a wall portion having an opening into which the liquid introduction portion is inserted and coupled to the liquid supply portion, a plurality of welding projection portions, which are a plurality of projection portions arranged along an outer edge of the opening in a state of being spaced apart, and a plurality of heat welding portions attached to a portion of a surface of the plurality of welding projection portions, and disposed in a state of being spaced apart, and a sheet bonded to the plurality of welding projection portions configured to be peeled off, while covering the opening, the plurality of welding projection portions, and the plurality of heat welding portions, in which the plurality of welding projection portions are projection portions before being heat-welded to the sheet formed at the wall portion, and are portions not melted by heat welding among projection portions made of a material configured to be heat-welded, and the plurality of heat welding portions are portions formed by being melted by heat welding among the projection portions before being heat-welded to the sheet, and a portion of which are in contact with the sheet.

According to a second aspect of the present disclosure, there is provided a method of heat welding a sheet. The method of heat welding a sheet includes forming a plurality of welding projection portions, which are portions not melted by heat welding of an attachment portion, which is a projection portion made of a material configured to be heat-welded, and a plurality of projection portions arranged along an outer edge of an opening, which is formed at a wall portion of an accommodation portion that accommodates a portion of a liquid supply portion configured to cause a liquid accommodated in a liquid accommodation portion to flow out to a printing apparatus therein, in a state of being spaced apart, and a plurality of heat welding portions formed by melting by heat welding and are attached to a portion of a surface of the plurality of welding projection portions among the attachment portion, and are disposed in a state of being spaced apart, by heat-welding the attachment portion and a sheet made of a material configured to be heat-welded, by using a welding member, in a state where the opening and the attachment portion are covered with the sheet.

### BRIEF DESCRIPTION OF THE DRAWINGS

FIG. 1 is a perspective view illustrating a configuration of a printing system according to an embodiment of the present disclosure.

FIG. 2 is a view illustrating a cartridge mounting portion.

FIG. 3 is a view illustrating a mounted state where mounting of the cartridge on the cartridge mounting portion is completed.

FIG. 4 is a view of the cartridge mounting portion in FIG. 2 as viewed in the −Z direction.

FIG. 5 is a perspective view of the cartridge.

FIG. 6 is a perspective view of the cartridge before being heat-welded to a sheet.

FIG. 7 is a view illustrating a state where a cartridge with the sheet peeled off is inserted into the cartridge mounting portion.

FIG. 8 is a view of the cartridge in FIG. 5 as viewed in the +Z direction.

FIG. 9 is a cross-sectional view taken along line IX-IX in FIG. 8.

FIG. 10 is a schematic drawing illustrating an accommodation bottom wall in FIG. 5 as viewed in the +Z direction.

FIG. 11 is an enlarged view of a portion of the accommodation bottom wall of the cartridge in FIG. 6.

FIG. 12 is a cross-sectional view taken along line XII-XII in FIG. 10.

FIG. 13 is an enlarged view of the vicinity of an XII-XII cross section in FIG. 10.

FIG. 14 is a view illustrating a mounting process, which is a process of mounting of the cartridge on the cartridge mounting portion.

FIG. 15 is a view illustrating a mounted state where mounting of the cartridge on the cartridge mounting portion is completed.

FIG. 16 is a view of FIG. 15 as viewed in a −Z direction.

FIG. 17 is a diagram illustrating a first welding member.

FIG. 18 is a flowchart illustrating an example of a method of heat welding a sheet.

FIG. 19 is a view illustrating a cartridge according to a second embodiment.

FIG. 20 is a diagram illustrating a cartridge in a state where a sheet is heat-welded.

FIG. 21 is a diagram illustrating a second welding member.

### DESCRIPTION OF EMBODIMENTS

### A. First Embodiment

### A1. Configuration of First Embodiment

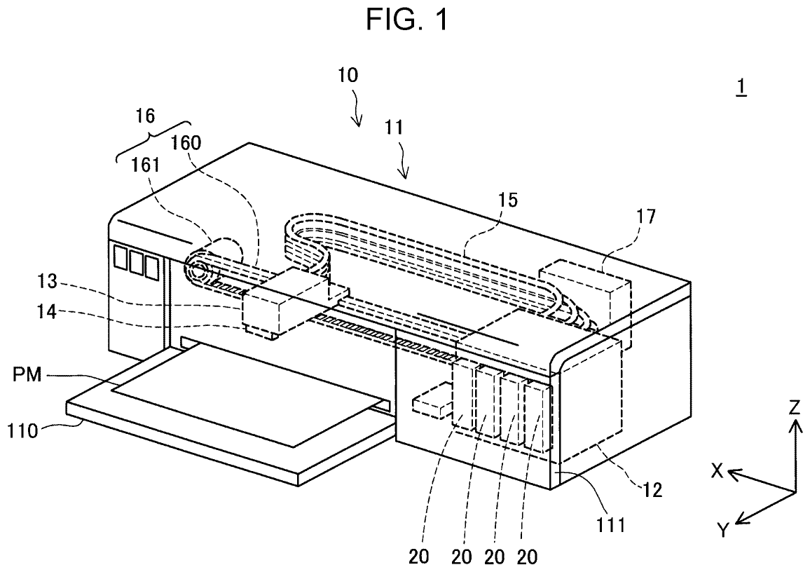

FIG. 1 is a perspective view illustrating a configuration of a printing system 1 according to an embodiment of the present disclosure. FIG. 1 illustrates an X-axis, a Y-axis, and a Z-axis which are three spatial axes orthogonal to each other. Directions in which arrows of the X-axis, the Y-axis, and the Z-axis are directed indicate positive directions along the X-axis, the Y-axis, and the Z-axis, respectively. The positive directions along the X-axis, the Y-axis, and the Z-axis are a +X direction, a +Y direction, and a +Z direction, respectively. Directions opposite to the directions in which the arrows of the X-axis, the Y-axis, and the Z-axis are directed indicate negative directions along the X-axis, the Y-axis, and the Z-axis, respectively. The negative directions along the X-axis, the Y-axis, and the Z-axis are a −X direction, a −Y direction, and a −Z direction, respectively. When positiveness and negativeness in directions along the X-axis, the Y-axis, and the Z-axis do not matter, the directions may be referred to as an X direction, a Y direction, and a Z direction, respectively. The same applies to the drawings and descriptions shown below. The X-axis and the Y-axis are axes along the horizontal plane, and the Z-axis is an axis along the direction of gravity.

The printing system 1 performs printing on a print medium PM by using ink. In the present embodiment, the printing system 1 performs printing using a plurality of inks. The printing system 1 is provided with a printing apparatus 10 and four cartridges 20. The printing apparatus 10 is an ink jet printer that ejects ink as a liquid and performs printing on the print medium PM. The cartridge 20 can be mounted on or removed from the printing apparatus 10.

As illustrated in FIG. 1, the printing apparatus 10 is used in a state of being disposed on a horizontal plane. The printing apparatus 10 is provided with an accommodation box 11, a cartridge mounting portion 12, a carriage 13, an ejection head 14, a tube 15, a drive mechanism 16, and a control portion 17.

The accommodation box 11 accommodates the cartridge mounting portion 12, the carriage 13, the ejection head 14, the drive mechanism 16, the control portion 17, and the cartridge 20. The accommodation box 11 has a substantially rectangular parallelepiped shape. The accommodation box 11 is provided with a front cover 110 and a replacement cover 111. The front cover 110 is a portion where the print medium PM on which printing is completed is disposed. The front cover 110 is provided on a wall on the +Y direction side of the accommodation box 11. The front cover 110 is a plate-shaped member extending in the X and Y directions. The replacement cover 111 is opened and closed when the cartridge 20 is attached to and detached from the cartridge mounting portion 12 by a user. The replacement cover 111 is a portion of the wall on the +Y direction side of the accommodation box 11.

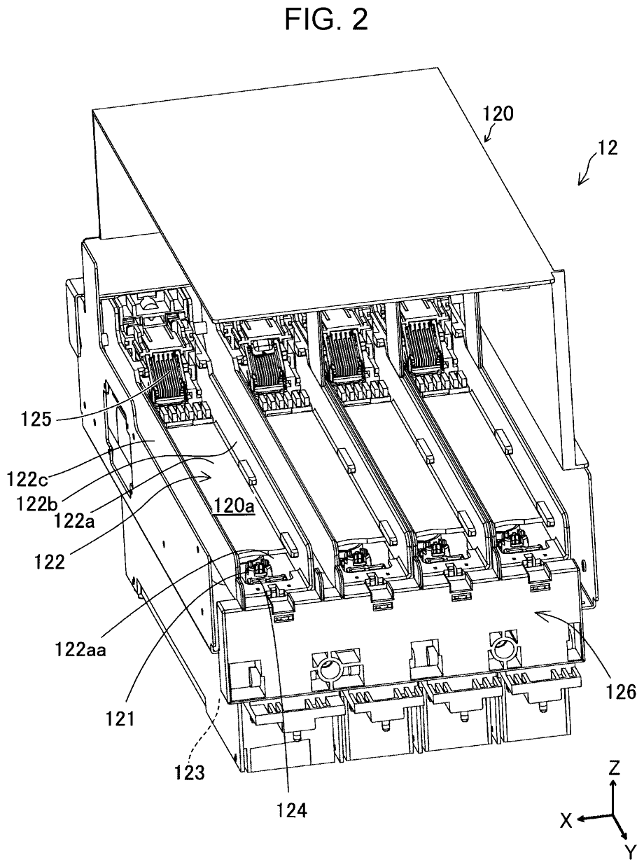

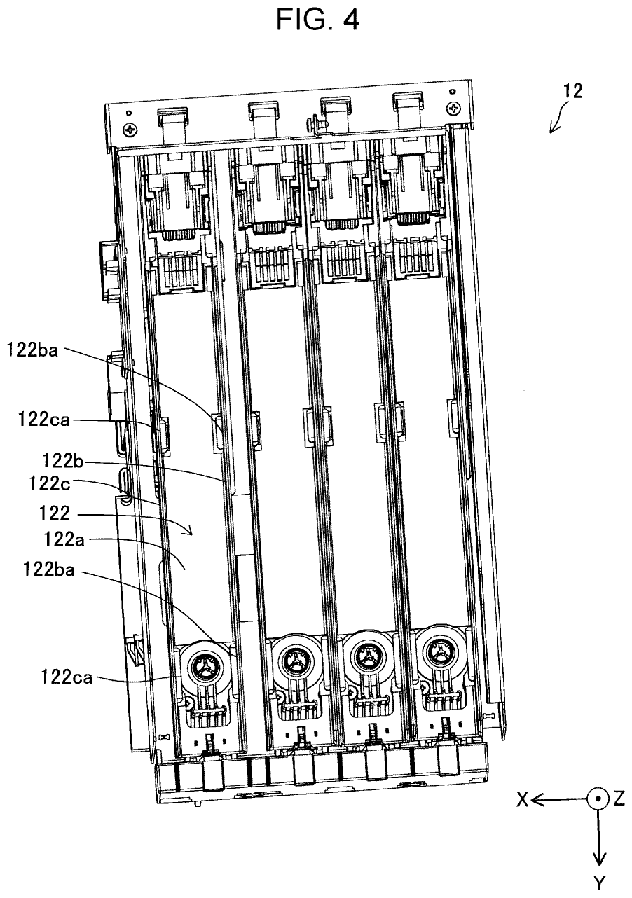

FIG. 2 is a view illustrating the cartridge mounting portion 12. In FIG. 2, the illustration of a portion of the cartridge 20 and the cartridge mounting portion 12 is omitted. The same applies to FIG. 4, which will be described later. In the present embodiment, the cartridge 20 is inserted into or taken out from the cartridge mounting portion 12 along the Y direction by the user. Specifically, the cartridge 20 is inserted into the cartridge mounting portion 12 in the −Y direction by the user. In addition, the cartridge 20 is pulled out from the cartridge mounting portion 12 in the +Y direction by the user.

The cartridge mounting portion 12 supplies the ink supplied from the cartridge 20 to the ejection head 14 via a tube 15 illustrated in FIG. 1. The cartridge mounting portion 12 is positioned on the −Y direction side of the replacement cover 111 inside the accommodation box 11. As illustrated in FIG. 2, the cartridge mounting portion 12 is provided with a mounting box 120, four liquid introduction portions 121, four support members 122, four liquid storage portions 123, and four apparatus-side supply portion positioning portions 124, four apparatus-side terminal portions 125, and an engagement forming body 126. In FIG. 2, the liquid introduction portion 121, which is positioned closest to the +X direction, the support member 122, the liquid storage portion 123, the apparatus-side supply portion positioning portion 124, and the apparatus-side terminal portion 125 are denoted by reference numerals.

The mounting box 120 forms an accommodation chamber 120a in which the cartridge 20 is accommodated. The mounting box 120 has a substantially rectangular box shape with an open surface on the +Y direction side. In FIG. 2, for easy description, a view is illustrated in which the mounting box 120 is partially opened on the +X direction side. In the mounting box 120, the four support members 122, the four liquid storage portions 123, the four apparatus-side supply portion positioning portions 124, the four apparatus-side terminal portions 125, and the engagement forming body 126 are disposed. In the following, the liquid introduction portion 121, which is positioned closest to the +X direction, the support member 122, the liquid storage portion 123, the apparatus-side supply portion positioning portion 124, the apparatus-side terminal portion 125, and the engagement forming body 126 will be described.

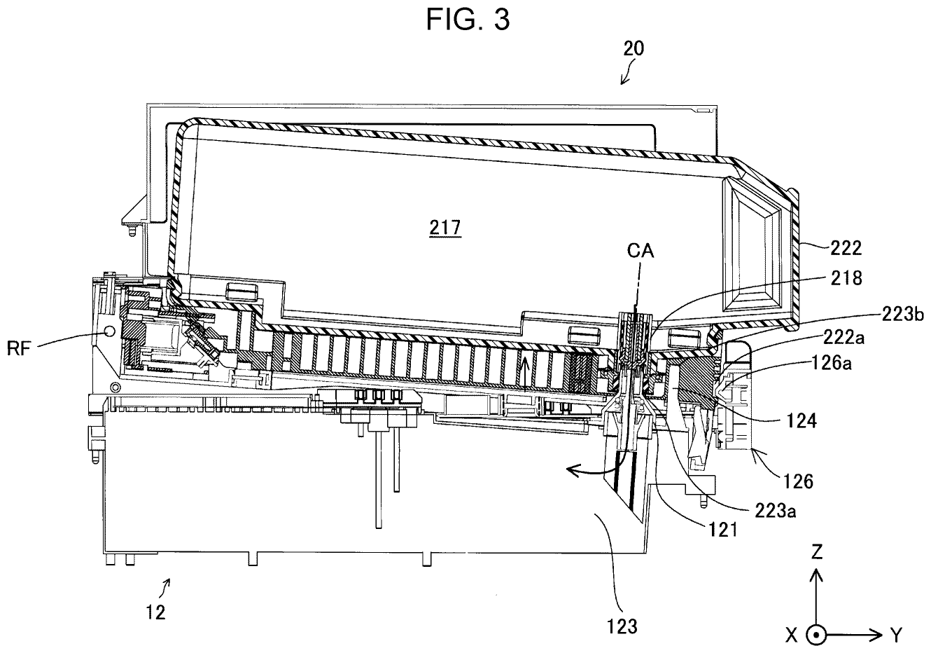

FIG. 3 is a cross-sectional view illustrating a mounted state where mounting of the cartridge 20 on the cartridge mounting portion 12 is completed. Here, the liquid introduction portion 121 will be described with reference to FIG. 3. The liquid introduction portion 121 receives ink supplied from a liquid supply portion 218 of the cartridge 20. The liquid supply portion 218 will be described later. The liquid introduction portion 121 is a cylindrical member. The liquid introduction portion 121 has a flow path for flowing the ink therein. The liquid introduction portion 121 is coupled to the liquid storage portion 123 and causes the ink flown through the flow path to flow into the liquid storage portion 123. As illustrated in FIG. 2, the liquid introduction portion 121 is provided on the −Y direction side with respect to the apparatus-side supply portion positioning portion 124.

The support member 122 forms a bottom of the accommodation chamber 120a. The support member 122 supports the cartridge 20 accommodated in the accommodation chamber 120a in the +Z direction. In the present embodiment, the four support members 122 are arranged side by side in the X direction. The support member 122 has a shape that extends in the Y direction and is recessed in the −Z direction. The support member 122 is provided with a support bottom wall 122a, a first support side wall 122b, and a second support side wall 122c. The support bottom wall 122a supports the cartridge 20 in the Z direction. The support bottom wall 122a is provided with a support opening portion 122aa. The liquid introduction portion 121 is disposed inside the support opening portion 122aa. The support opening portion 122aa is formed at the end portion of the support bottom wall 122a on the +Y direction side. The support opening portion 122aa penetrates in the Z direction. The support opening portion 122aa is formed from a first support side wall 122b to a second support side wall 122c in the X direction.

FIG. 4 is a view of the cartridge mounting portion 12 in FIG. 2 as viewed in the +Z direction. In FIG. 4, a portion of the cartridge mounting portion 12 illustrated in FIG. 2 is omitted. The first support side wall 122b supports the cartridge 20 on the −X direction side. The first support side wall 122b extends in the +Z direction from the support bottom wall 122a at the end portion of the support bottom wall 122a on the −X direction side. The first support side wall 122b is provided with a first mounting guide portion 122ba. The first mounting guide portion 122ba guides the cartridge 20 in an insertion direction and a removal direction when the cartridge 20 is mounted by the user. As illustrated in FIG. 4, the first mounting guide portion 122ba is a projection portion that projects toward the second support side wall 122c. The first mounting guide portion 122ba extends along the Y direction. In the present embodiment, two first mounting guide portions 122ba are disposed at an interval in the Y direction. The second support side wall 122c supports the cartridge 20 on the +X direction side. The second support side wall 122c extends in the +Z direction from the support bottom wall 122a at the end portion of the support bottom wall 122a on the +X direction side. The second support side wall 122c faces the first support side wall 122b in the X direction. The second support side wall 122c is provided with a second mounting guide portion 122ca. The second mounting guide portion 122ca guides the cartridge 20 in the insertion direction and the removal direction when the cartridge 20 is mounted by the user. As illustrated in FIG. 4, the second mounting guide portion 122ca is a projection portion that projects toward the first support side wall 122b. The second mounting guide portion 122ca extends along the Y direction. In the present embodiment, two second mounting guide portions 122ca are disposed at an interval in the Y direction.

The liquid storage portion 123 illustrated in FIG. 2 stores the ink received from the cartridge 20 via the liquid introduction portion 121. The liquid introduction portion 121 communicates with the ejection head 14 via the tube 15 illustrated in FIG. 1. The liquid storage portion 123 is positioned on the −Z direction side of the liquid introduction portion 121. The apparatus-side supply portion positioning portion 124 is a portion that enters the supply portion positioning portion 223b of the cartridge 20 during the mounting process of the cartridge 20 to the cartridge mounting portion 12. In a state after the terminal coupling process described later and before the supply portion coupling process, the liquid introduction portion 121 faces the opening 223a of the accommodation portion 220 in the Z direction. The supply portion positioning portion 223b, the accommodation portion 220, the opening 223a, and the mounting process will be described later. The apparatus-side supply portion positioning portion 124 has a substantially rectangular parallelepiped shape.

The apparatus-side terminal portion 125 is electrically coupled by coming into contact with a circuit substrate 250 of the cartridge 20 in a state where the cartridge 20 is mounted on the cartridge mounting portion 12. The circuit substrate 250 will be described later. The apparatus-side terminal portion 125 is electrically coupled to the control portion 17 in FIG. 1 by wiring (not illustrated). As a result, the circuit substrate 250 and the control portion 17 can perform data communication. The engagement forming body 126 maintains the mounted state of the cartridge 20 in the cartridge mounting portion 12 by engaging with the cartridge 20 when the cartridge 20 is mounted on the cartridge mounting portion 12. The engagement forming body 126 is provided at the end of the cartridge mounting portion 12 on the +Y direction side. As illustrated in FIG. 3, the engagement forming body 126 has a mounting engagement portion 126a. The mounting engagement portion 126a holds the mounted state of the cartridge 20 by being engaged with the cartridge engagement portion 222a of the cartridge 20. The cartridge engagement portion 222a will be described later.

The carriage 13 illustrated in FIG. 1 moves the ejection head 14 relative to the print medium PM. Specifically, the carriage 13 moves the ejection head 14 by reciprocating in the X direction. The ejection head 14 ejects ink toward the print medium PM to print data such as a character or an image on the print medium PM. The tube 15 causes the ink inside the liquid storage portion 123 of the cartridge mounting portion 12 to flow, and supplies the ink to the ejection head 14.

The drive mechanism 16 causes the carriage 13 to reciprocate in the X direction based on a control signal from the control portion 17. The drive mechanism 16 is provided with a timing belt 160 and a drive motor 161. The timing belt 160 transmits the power of the drive motor 161 to the carriage 13. The drive motor 161 rotates the timing belt 160. The control portion 17 controls each section of the printing apparatus 10 and exchanges signals with the cartridge 20.

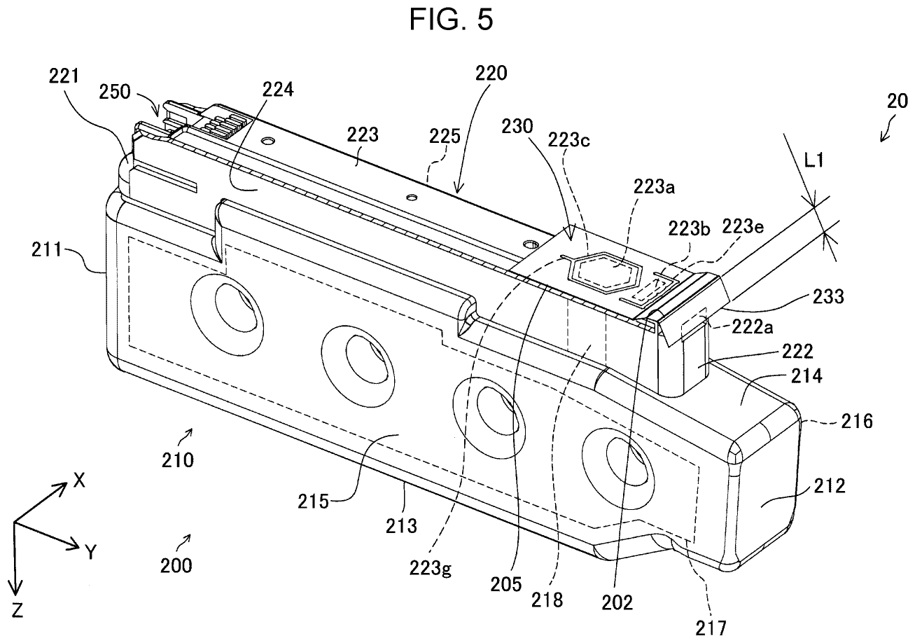

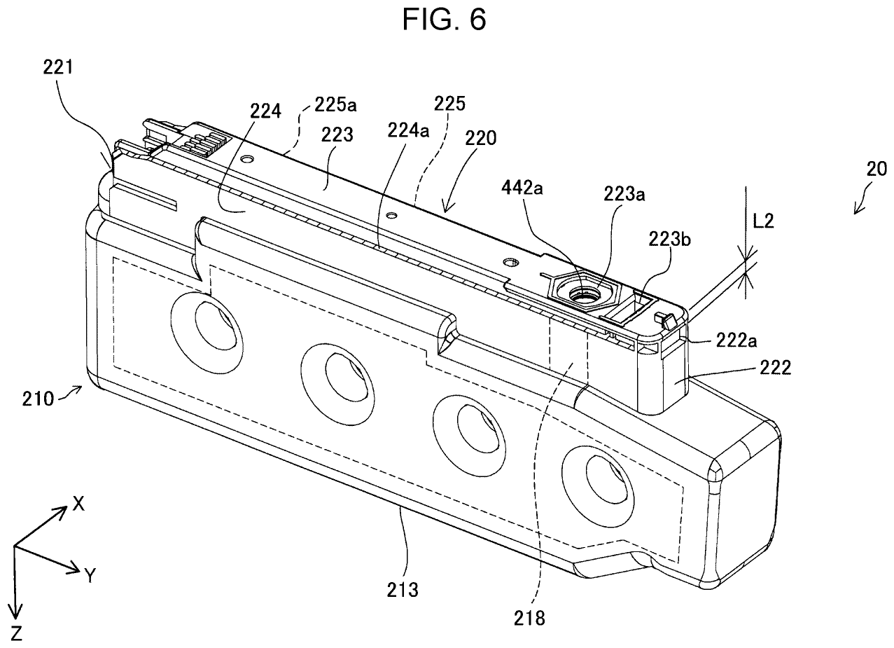

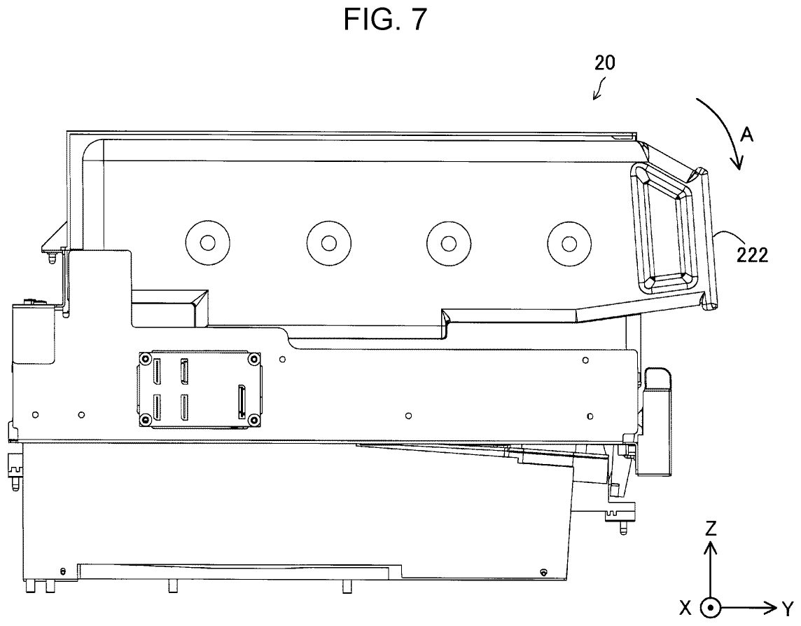

FIG. 5 is a perspective view of the cartridge 20. FIG. 6 is a perspective view of the cartridge 20 before being heat-welded to the sheet 230. The sheet 230 will be described later. FIG. 7 is a view illustrating a state where the cartridge 20 with the sheet 230 peeled off is inserted into the cartridge mounting portion 12. The X direction, the Y direction, and the Z direction illustrated in FIGS. 5 and 6 are based on a state where the insertion of the cartridge 20 illustrated in FIG. 7 into the cartridge mounting portion 12 is completed. The cartridge 20 accommodates ink to be supplied to the printing apparatus 10. The cartridge 20 can be mounted on or removed from the printing apparatus 10. As illustrated in FIG. 1, in the present embodiment, the four cartridges 20 are mounted on the printing apparatus 10. The cartridge 20 has a substantially rectangular parallelepiped shape. In the cartridge 20, the X direction is the lateral direction of the cartridge 20, the Y direction is the longitudinal direction, and the Z direction is the height direction. In the cartridge 20, the dimension in the longitudinal direction is the largest and the dimension in the lateral direction is the smallest. As illustrated in FIG. 5, the cartridge 20 is provided with a cartridge main body 200 and a circuit substrate 250.

The cartridge main body 200 is provided with a liquid accommodation body 210, an accommodation portion 220, and a sheet 230. The liquid accommodation body 210 accommodates ink as a liquid. The liquid accommodation body 210 has a substantially rectangular shape. The liquid accommodation body 210 is provided with a front wall 211, a rear wall 212, an upper wall 213, a bottom wall 214, a first side wall 215, a second side wall 216, a liquid accommodation portion 217, and a liquid supply portion 218. The front wall 211 forms a wall portion of the liquid accommodation body 210 on the −Y direction side. The rear wall 212 forms a wall portion of the liquid accommodation body 210 on the +Y direction side. The rear wall 212 faces the front wall 211 in the Y direction. The upper wall 213 forms a wall portion of the liquid accommodation body 210 on the +Z direction side. The bottom wall 214 forms a wall portion of the liquid accommodation body 210 on the −Z direction side. The bottom wall 214 faces the upper wall 213 in the Z direction. The first side wall 215 forms a wall portion of the liquid accommodation body 210 on the −X direction side. The second side wall 216 forms a wall portion of the liquid accommodation body 210 on the +X direction side. The second side wall 216 faces the first side wall 215 in the X direction.

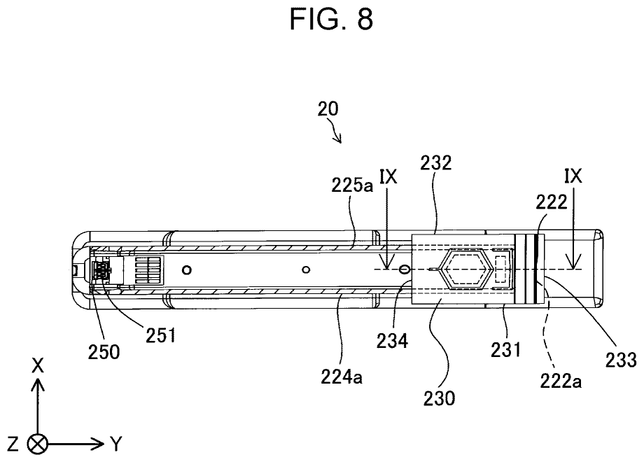

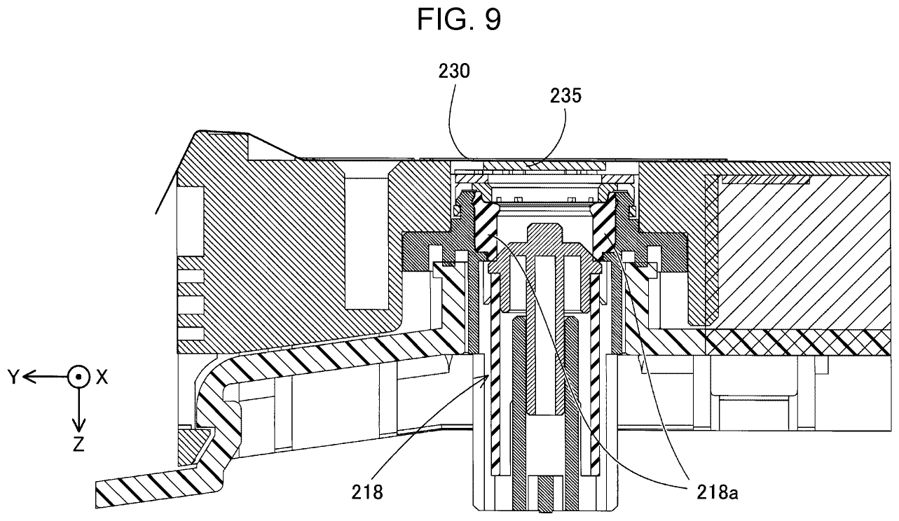

FIG. 8 is a view of the cartridge 20 in FIG. 5 as viewed in the +Z direction. FIG. 9 is a cross-sectional view taken along line IX-IX in FIG. 8. The liquid accommodation portion 217 illustrated in FIG. 5 is a portion that accommodates the ink. The liquid accommodation portion 217 is molded by injection molding of polypropylene as a material. The liquid supply portion 218 can flow the ink of the liquid accommodation portion 217. As illustrated in FIG. 3, the liquid supply portion 218 is coupled to the liquid introduction portion 121 of the cartridge mounting portion 12 in a state where the cartridge 20 is mounted on the cartridge mounting portion 12. The liquid supply portion 218 supplies the ink accommodated in the liquid accommodation portion 217 to the ejection head 14 of the printing apparatus 10 illustrated in FIG. 1 through the liquid introduction portion 121. In the present embodiment, the liquid supply portion 218 is a cylindrical member. The liquid supply portion 218 is provided with a valve mechanism that opens a valve when the liquid introduction portion 121 is inserted into the opening 223a of the accommodation portion 220 illustrated in FIG. 6, and closes the valve in a state where the liquid introduction portion 121 is not inserted into the opening 223a. As illustrated in FIG. 9, the liquid supply portion 218 has a packing 218a inside. Although not illustrated in the drawing, the space between the liquid introduction portion 121 and the liquid supply portion 218 is sealed by the packing 218a in a state where the liquid introduction portion 121 is inserted. As a result, it is possible to prevent the ink inside the liquid accommodation portion 217 from leaking from the space between the liquid supply portion 218 and the liquid introduction portion 121.

The accommodation portion 220 illustrated in FIG. 6 accommodates a portion of the liquid supply portion 218 therein. The accommodation portion 220 is attached to the liquid accommodation portion 217. The accommodation portion 220 has a substantially rectangular shape that is open on the +Z direction side. The accommodation portion 220 is molded by injection molding of polypropylene as a material. The accommodation portion 220 is provided with an accommodation front wall 221, an accommodation rear wall 222, an accommodation bottom wall 223, a first accommodation side wall 224, and a second accommodation side wall 225. The accommodation front wall 221 forms a wall portion of the accommodation portion 220 on the −Y direction side. The accommodation rear wall 222 forms a wall portion of the accommodation portion 220 on the side of the +Y direction. The accommodation rear wall 222 faces the accommodation front wall 221 in the Y direction. The accommodation rear wall 222 is provided with a cartridge engagement portion 222a. As illustrated in FIG. 3, the cartridge engagement portion 222a is engaged with the mounting engagement portion 126a when the mounting engagement portion 126a of the cartridge mounting portion 12 is inserted therein in a state where the cartridge 20 is mounted on the cartridge mounting portion 12. By the engagement, the mounted state of the cartridge 20 with respect to the cartridge mounting portion 12 is maintained. As illustrated in FIG. 6, the cartridge engagement portion 222a is a recessed portion that is recessed in the −Y direction from the outer surface of the accommodation rear wall 222. The cartridge engagement portion 222a is formed at the vicinity of an end portion of the accommodation rear wall 222 intersecting with the accommodation bottom wall 223.

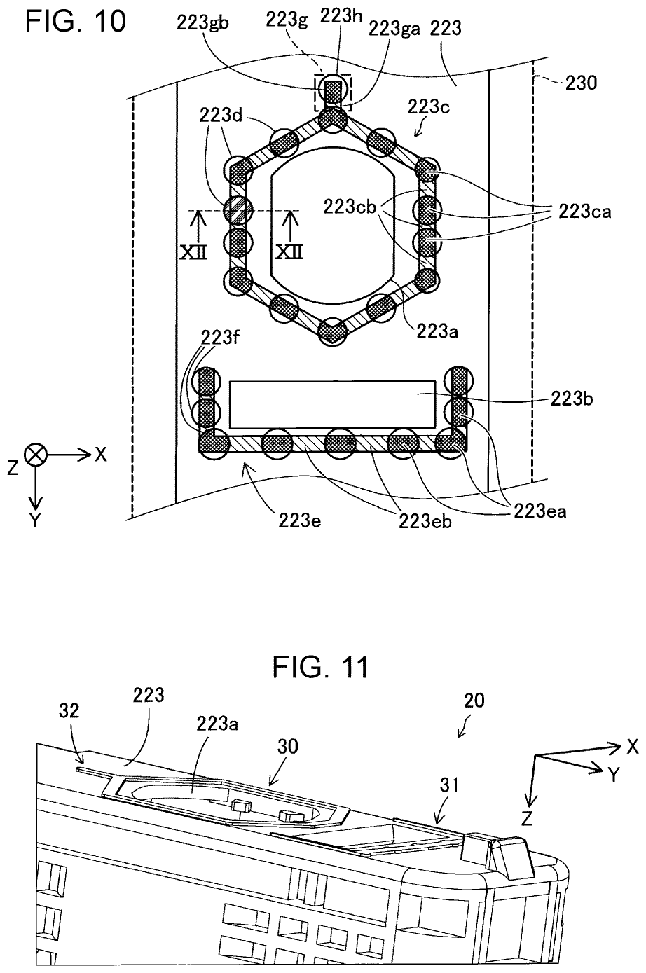

FIG. 10 is a schematic drawing illustrating the accommodation bottom wall 223 in FIG. 5 as viewed in the +Z direction. In FIG. 10, the sheet 230 is illustrated transparently. As illustrated in FIG. 5, the accommodation bottom wall 223 forms a wall portion of the accommodation portion 220 on the −Z direction side. As illustrated in FIGS. 5 and 10, the accommodation bottom wall 223 includes an opening 223a, a supply portion positioning portion 223b, a first projection portion for welding 223c, 14 first heat welding portions 223d, a second projection portion for welding 223e, nine second heat welding portions 223f, a third projection portion for welding 223g, and the third heat welding portion 223h. In FIG. 10, the first projection portion for welding 223c, the second projection portion for welding 223e, and the third projection portion for welding 223g are hatched. In addition, in FIG. 10, the first heat welding portion 223d, the second heat welding portion 223f, and the third heat welding portion 223h are illustrated transparently, and the first heat welding portion 223d positioned on the XII-XII cross section described later is hatched. The shapes of the first projection portion for welding 223c, the second projection portion for welding 223e, the third projection portion for welding 223g, the first heat welding portion 223d, the second heat welding portion 223f, and the third heat welding portion 223h in FIG. 10 are not accurate.

As illustrated in FIG. 3, the liquid introduction portion 121 is inserted into the opening 223a. The opening 223a is coupled to the liquid supply portion 218. The opening 223a passes through the central axis CA of the liquid supply portion 218 when viewed in the Z direction. In the present embodiment, the opening 223a has a substantially circular shape when viewed in the Z direction. The supply portion positioning portion 223b is a portion that receives the apparatus-side supply portion positioning portion 124 of the cartridge mounting portion 12 when the cartridge 20 is mounted on the cartridge mounting portion 12. The supply portion positioning portion 223b positions the liquid supply portion 218 with respect to the liquid introduction portion 121. The positioning will be described later. The supply portion positioning portion 223b is positioned on the +Y direction side with respect to the opening 223a. As illustrated in FIG. 6, the supply portion positioning portion 223b is a recessed portion recessed in the +Z direction on the outer surface of the bottom wall 214.

FIG. 11 is an enlarged view of a portion of the accommodation bottom wall 223 of the cartridge 20 in FIG. 6. Before describing the first projection portion for welding 223c, the cartridge 20 before being heat-welded to the sheet 230 will be described. As illustrated in FIG. 11, in a state before being heat-welded to the sheet 230, the cartridge 20 is provided with a first attachment portion 30, a second attachment portion 31, and a third attachment portion 32. The first attachment portion 30, the second attachment portion 31, and the third attachment portion 32 are projection portions formed at the accommodation bottom wall 223 of the cartridge 20 before being heat-welded to the sheet 230. As illustrated in FIG. 11, the first attachment portion 30, the second attachment portion 31, and the third attachment portion 32 project from the accommodation bottom wall 223 in the −Z direction. The first attachment portion 30, the second attachment portion 31, and the third attachment portion 32 are made of a material that can be heat-welded. In the present embodiment, the first attachment portion 30, the second attachment portion 31, and the third attachment portion 32 are made of polypropylene. The first attachment portion 30 is one continuous projection portion that surrounds the opening 223a. In the first attachment portion 30, the contour has a hexagonal shape when viewed in the Z direction. The second attachment portion 31 is one continuous projection portion that is arranged along an edge other than the edge on the opening 223a side of the supply portion positioning portion 223b. The third attachment portion 32 is coupled to an end portion of the first attachment portion 30 on the −Y direction side. The third attachment portion 32 has a rectangular shape when viewed in the Z direction.

The first projection portion for welding 223c illustrated in FIG. 10 is one continuous projection portion that surrounds the opening 223a. The first projection portion for welding 223c overlaps the sheet 230 when viewed in the +Z direction. The first projection portion for welding 223c projects from the accommodation bottom wall 223. In the first projection portion for welding 223c, the contour has a hexagonal shape when viewed in the Z direction. The first projection portion for welding 223c is provided with 14 first welding projection portion 223ca and 14 first coupling portions 223cb.

The first welding projection portion 223ca is a portion that is not melted by heat welding of the first attachment portion 30 illustrated in FIG. 11. As illustrated in FIG. 10, the 14 first welding projection portions 223ca are arranged along the outer edge of the opening 223a in a state of being spaced apart from each other. Among the 14 first welding projection portions 223ca, each of the six first welding projection portions 223ca is disposed at the vertex of the first projection portion for welding 223c, which is a hexagon when viewed in the Z direction. The disposition at the vertex in the present specification means that the first welding projection portions 223ca are disposed at a position including the vertex. Each of the eight first welding projection portions 223ca that are not disposed at the vertices is disposed at the side of the first projection portion for welding 223c. The shape of the first welding projection portion 223ca in FIG. 10 is not accurate. Each of the 14 first projection portions for welding 223c corresponds to the shape of the portion of the first attachment portion 30 to be melted. Each shape of the first projection portion for welding 223c formed by melting a portion of the first attachment portion 30 including the vertices of the hexagon when viewed in the Z direction and the first projection portion for welding 223c formed by melting a portion of the side of the first attachment portion 30 is different from each other.

The first coupling portion 223cb couples the first welding projection portions 223ca adjacent to each other. As a result, a plurality of first welding projection portions 223ca and the first coupling portion 223cb constitute the first projection portion for welding 223c, which is one continuous projection portion, surrounding the opening 223a. In the present embodiment, each of the 14 first coupling portions 223cb is continuously in contact with the sheet 230 between the first welding projection portions 223ca adjacent to each other. Specifically, each of the 14 first coupling portions 223cb is in continuous contact with the sheet 230 from an end portion coupled to the first welding projection portion 223ca to an end portion coupled to the facing first welding projection portions 223ca on the outer surface on the −Z direction side. That is, it is configured that there is no gap between the first coupling portion 223cb and the sheet 230 when viewed in the X direction. In the present embodiment, the first coupling portion 223cb is disposed at the side of the first projection portion for welding 223c.

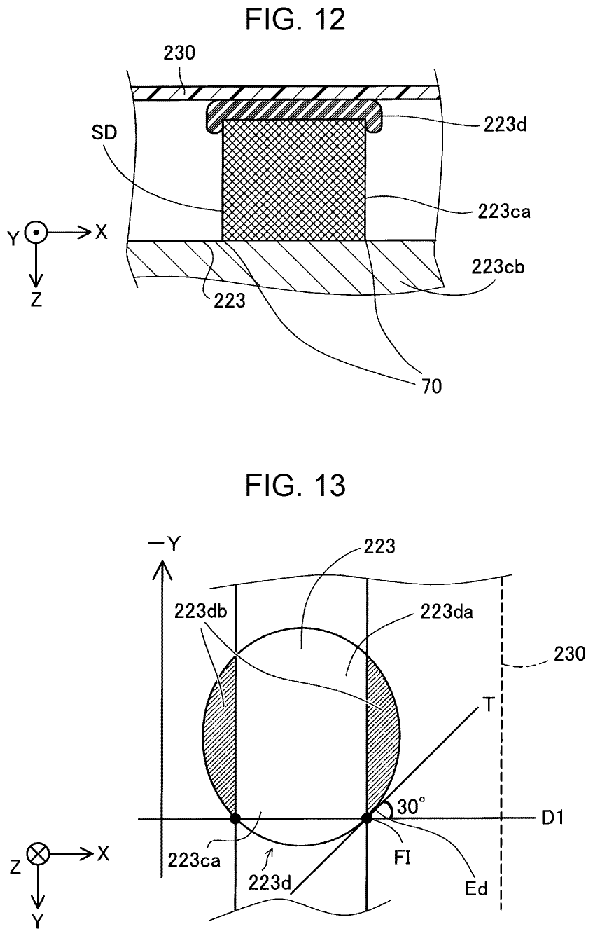

FIG. 12 is a cross-sectional view taken along line XII-XII in FIG. 10. In FIG. 12, hatching corresponding to the first welding projection portion 223ca and the first heat welding portion 223d in FIG. 10 is added. The dimensions and shape of each section in FIG. 12 are not accurate. A first heat welding portion 223d illustrated in FIG. 12 is a portion formed by melting by heat welding of the first attachment portion 30 in FIG. 11. A portion of the first welding projection portion 223ca is in contact with the sheet 230. Specifically, as illustrated in FIG. 12, the surface of the first heat welding portion 223d on the −Z direction side adheres to the sheet 230. Each of the 14 first heat welding portions 223d is attached to a portion of the surface of the 14 first welding projection portions 223ca.

As illustrated in FIG. 12, the first heat welding portion 223d is formed from the end portion of the first welding projection portion 223ca on the −Z direction side over a portion of a stepped portion SD of the accommodation bottom wall 223 where the first projection portion for welding 223c is not formed. The portion of the first heat welding portion 223d formed in the stepped portion SD is a portion in which the portion of the first attachment portion 30 melted by heat welding flows into the stepped portion SD and is solidified at the stepped portion SD. The same applies to the other first heat welding portions 223d not illustrated in FIG. 12. Each of the 14 first heat welding portions 223d corresponds to the shape of the portion of the first attachment portion 30 to be melted. Each shape of the first heat welding portion 223d formed by melting a portion of the first attachment portion 30 including the vertices of the hexagon when viewed in the Z direction and the first heat welding portion 223d formed by melting a portion of the side of the first attachment portion 30 is different from each other. As illustrated in FIGS. 10 and 12, the first heat welding portion 223d of the present embodiment covers an outer surface of the first welding projection portion 223ca on the −Z direction side. When viewed in the +Z direction, each of the 14 first heat welding portions 223d overlaps so as to include one of the 14 first welding projection portions 223ca. Each of the 14 first heat welding portions 223d is disposed in a state of being spaced apart. Each of the 14 first heat welding portions 223d is arranged along the outer edge of the opening 223a.

FIG. 13 is an enlarged view of the vicinity of an XII-XII cross section in FIG. 10. In the present embodiment, the first heat welding portion 223d positioned on the sides of the hexagon of the first projection portion for welding 223c when viewed in the Z direction, as illustrated in FIG. 10 has an elliptical shape when viewed in the +Z direction, as illustrated in FIG. 13. The first heat welding portions 223d positioned on the sides of the hexagon will be described below. The first heat welding portion 223d is provided with an overlapping portion 223da and a non-overlapping portion 223db. In FIG. 13, the non-overlapping portion 223db is hatched. The overlapping portion 223da is a portion that overlaps the first welding projection portion 223ca when viewed in the +Z direction. The non-overlapping portion 223db is a portion that does not overlap the first welding projection portion 223ca when viewed in the +Z direction. As illustrated in FIG. 13, among the intersections with a line defining the overlapping portion 223da and the non-overlapping portion 223db on the outer periphery of the first heat welding portion 223d, when viewed along the −Y direction, an intersection positioned closest to the front is referred to as a first intersection FI. In the present embodiment, as illustrated in FIG. 13, there are two intersections positioned closest to the front, and the intersection positioned on the +X direction side will be described below. Depending on the shape of the first heat welding portion 223d, the number of intersections may be one. In the present embodiment, the angle formed by a straight line D1 perpendicular to the −Y direction and the Z direction when viewed in the Z direction and a tangent T that passes through an end portion Ed when approaching the first intersection FI along the outer contour of the outer periphery of the non-overlapping portion 223db is 30°.

The second projection portion for welding 223e illustrated in FIG. 10 is one continuous projection portion that is arranged along the edge other than the edge on the opening 223a side of the supply portion positioning portion 223b. The second projection portion for welding 223e overlaps the sheet 230 when viewed in the +Z direction. The second projection portion for welding 223e projects from the accommodation bottom wall 223. The second projection portion for welding 223e is provided with nine second welding projection portions 223ea and eight second coupling portions 223eb.

The second welding projection portion 223ea is a portion that is not melted by heat welding of the second attachment portion 31 illustrated in FIG. 11. As illustrated in FIG. 10, the nine second welding projection portions 223ea are arranged along the outer edge of the supply portion positioning portion 223b in a state of being spaced apart from each other. Among the nine second welding projection portions 223ea, each of two second welding projection portions 223ea is disposed at a position including the corner portion of the second projection portion for welding 223e. Each of the second welding projection portions 223ea that is not disposed at the position including the corner portion is disposed on the side. In addition, the shape of the second welding projection portion 223ea in FIG. 10 is not accurate. Similar to the first welding projection portion 223ca, each of the nine second welding projection portions 223ea corresponds to the shape of the portion of the second attachment portion 31 to be melted.

The second coupling portion 223eb couples the second welding projection portions 223ea adjacent to each other. As a result, a plurality of second welding projection portions 223ea and the second coupling portion 223eb constitute one continuous projection portion along the supply portion positioning portion 223b. In the present embodiment, each of the eight second coupling portions 223eb is continuously in contact with the sheet 230 between the second welding projection portions 223ea adjacent to each other. Specifically, each of the eight second coupling portions 223eb is in continuous contact with the sheet 230 from an end portion coupled to the second welding projection portion 223ea to an end portion coupled to the facing second welding projection portion 223ea on the outer surface on the −Z direction side. That is, it is configured that there is no gap between the second coupling portion 223eb and the sheet 230 when viewed in the X direction.

The second heat welding portion 223f is a portion formed by melting by heat welding another portion of the second attachment portion 31 in FIG. 11. In the second heat welding portion 223f illustrated in FIG. 10, a portion of the second welding projection portion 223ea is in contact with the sheet 230. Specifically, similar to the first heat welding portion 223d, the surface of the second heat welding portion 223f on the −Z direction side adheres to the sheet 230. Each of the nine second heat welding portions 223f is attached to a portion of the surface of the nine second welding projection portions 223ea, similar to the first heat welding portion 223d. That is, the second heat welding portion 223f is formed from the end portion of the second welding projection portion 223ea on the −Z direction side over a portion of the stepped portion of the accommodation bottom wall 223 where the second projection portion for welding 223e is not formed. The portion of the second heat welding portion 223f formed in the stepped portion is a portion in which the portion of the second projection portion for welding 223e melted by heat welding flows into the stepped portion and is solidified at the stepped portion. Each of the nine second heat welding portions 223f corresponds to the shape of the portion of the second attachment portion 31 to be melted. Each shape of the second heat welding portion 223f formed by melting the corner portion of the second attachment portion 31 and the second heat welding portion 223f formed by melting a portion of the side of the second attachment portion 31 is different from each other.

As illustrated in FIG. 10, the second heat welding portion 223f of the present embodiment covers the outer surface of the second welding projection portion 223ea on the −Z direction side. When viewed in the +Z direction, each of the nine second heat welding portions 223f overlaps so as to include one of the nine second welding projection portions 223ea. Each of the nine second heat welding portions 223f is disposed in a state of being spaced apart. Each of the second heat welding portions 223f is arranged along the outer edge of the supply portion positioning portion 223b.

The third projection portion for welding 223g is a projection portion that is coupled to the end portion of the first projection portion for welding 223c closest to the −Y direction side, and projects from the first projection portion for welding 223c in the −Y direction. The third projection portion for welding 223g is provided with a third coupling portion 223ga and a third welding projection portion 223gb. The third coupling portion 223ga is a portion coupled to the first projection portion for welding 223c. The third welding projection portion 223gb is a portion that is not melted by heat welding of the third attachment portion 32.

The third heat welding portion 223h is a portion formed by melting by heat welding of the third attachment portion 32 in FIG. 11. As illustrated in FIG. 10, the third heat welding portion 223h adheres to the surface of the third welding projection portion 223gb.

The first accommodation side wall 224 illustrated in FIG. 6 forms a wall portion of the accommodation portion 220 on the side of the −X direction. The first accommodation side wall 224 intersects the accommodation bottom wall 223 and extends in the Y direction, which is the longitudinal direction of the accommodation portion 220. The first accommodation side wall 224 extends from the accommodation bottom wall 223 toward the liquid accommodation body 210. The first accommodation side wall 224 is provided with a first cartridge guide portion 224a. The first cartridge guide portion 224a is guided in the −Y direction by the first mounting guide portion 122ba by coming into contact with the first mounting guide portion 122ba of the cartridge mounting portion 12 when the cartridge 20 is inserted into the cartridge mounting portion 12. The first cartridge guide portion 224a extends along the Y direction at an end portion of the first accommodation side wall 224 on the −Z direction side. The second accommodation side wall 225 faces the first accommodation side wall 224 in the X direction, which is the lateral direction of the accommodation portion 220. The second accommodation side wall 225 intersects the accommodation bottom wall 223 and extends in the Y direction, which is the longitudinal direction of the accommodation portion 220. The second accommodation side wall 225 is provided with a second cartridge guide portion 225a. The second cartridge guide portion 225a is guided in the −Y direction by the second mounting guide portion 122ca by coming into contact with the second mounting guide portion 122ca of the cartridge mounting portion 12 when the cartridge 20 is inserted into the cartridge mounting portion 12. The second cartridge guide portion 225a extends along the Y direction at the end portion of the second accommodation side wall 225 on the −Z direction side.

The sheet 230 illustrated in FIG. 5 can prevent foreign matter from entering the outside of the cartridge 20 by covering the opening 223a. More specifically, since the sheet 230 covers the opening 223a, it is possible to prevent foreign matter from adhering to the packing 218a of the liquid supply portion 218 coupled to the opening 223a. The sheet 230 can be peeled off from the accommodation bottom wall 223 in a state where the opening 223a, the first projection portion for welding 223c, the supply portion positioning portion 223b, the second projection portion for welding 223e, the third projection portion for welding 223g, the first heat welding portion 223d, the second heat welding portion 223f, and the third heat welding portion 223h are covered. The sheet 230 is bonded to the first welding projection portion 223ca so as to be peeled, the second welding projection portion 223ea, and the third welding projection portion 223gb via the first heat welding portion 223d, the second heat welding portion 223f, and the third heat welding portion 223h. The sheet 230 overlaps the first heat welding portion 223d, the second heat welding portion 223f, and the third heat welding portion 223h in the Z direction. Before the cartridge 20 is mounted on the cartridge mounting portion 12 by the user, the sheet 230 is peeled off from the accommodation bottom wall 223 in the −Y direction. The −Y direction is the direction where the sheet 230 is peeled off.

In the present embodiment, as illustrated in FIG. 8, when the cartridge 20 is viewed in the +Z direction, the sheet 230 is disposed so as to partially overlap the first cartridge guide portion 224a and the second cartridge guide portion 225a, and to project from the first cartridge guide portion 224a and the second cartridge guide portion 225a. Specifically, the sheet 230 is disposed such that a first sheet side portion 231 described later overlaps the first cartridge guide portion 224a and is positioned on the −X direction side from the first cartridge guide portion 224a. In addition, the sheet 230 is disposed such that a second sheet side portion 232 described later overlaps the second cartridge guide portion 225a and is positioned on the +X direction side from the second cartridge guide portion 225a. In the present embodiment, the dimension of the sheet 230 in the X direction is larger than an interval between the first cartridge guide portion 224a and the second cartridge guide portion 225a in the X direction.

In the present embodiment, the sheet 230 is partially formed with a fold along the X direction, which is the width direction. The fold is formed by sealing the cartridge 20 in a decompressed bag when the cartridge 20 is shipped. The sheet 230 has a rectangular shape in a state where no folds are formed. The sheet 230 is provided with a first sheet side portion 231, a second sheet side portion 232, a first sheet end portion 233, and a second sheet end portion 234 that define a rectangular outer shape, and the liquid absorbing material 235 illustrated in FIG. 9. As illustrated in FIG. 8, the first sheet side portion 231 forms one end portion in the X direction, which is the lateral direction of the cartridge 20. The second sheet side portion 232 forms the other end portion in the X direction. The first sheet end portion 233 forms one end portion in the Y direction, which is the longitudinal direction of the cartridge 20. The first sheet end portion 233 is positioned at the end portion of the sheet 230 on the +Y direction side of the cartridge 20. When viewed in the +Z direction, the first sheet end portion 233 projects outward from the accommodation rear wall 222 to the extent that the first sheet end portion 233 covers a portion of the cartridge engagement portion 222a illustrated in FIG. 5. As illustrated in FIG. 5, a length L1 of a portion of the sheet 230, which projects outward from the accommodation rear wall 222, is longer than a length L2 from the accommodation bottom wall 223 to the cartridge engagement portion 222a illustrated in FIG. 6. The second sheet end portion 234 illustrated in FIG. 8 forms an end portion of the sheet 230 on the −Y direction side of the cartridge 20.

The sheet 230 is made of a material that can be heat-welded. In the present embodiment, the sheet 230 is made of polyethylene terephthalate. Although not illustrated in FIG. 12, a portion of the sheet 230, which is in contact with the first heat welding portion 223d, the second heat welding portion 223f, and the third heat welding portion 223h, is deformed from the shape before being heat-welded by melting. The deformed portion is welded to the first heat welding portion 223d, the second heat welding portion 223f, and the third heat welding portion 223h.

The liquid absorbing material 235 illustrated in FIG. 9 is a member that absorbs the liquid. The liquid absorbing material 235 can absorb the ink accommodated in the cartridge 20. In the present embodiment, the liquid absorbing material 235 is disposed on the surface of the sheet 230 on the +Z direction side. Specifically, as illustrated in FIG. 9, the liquid absorbing material 235 is disposed at a portion facing the tip end of the liquid supply portion 218 on the surface of the sheet 230 on the +Z direction side. In the present embodiment, the liquid absorbing material 235 has a circular shape. The liquid absorbing material 235 is a member for holding the liquid by a predetermined capillary force. The liquid absorbing material 235 may be, for example, a foamed member such as urethane foam, a porous body made of polyvinyl alcohol, or a member made of non-woven fabric. Since the sheet 230 has the liquid absorbing material 235, even when the ink leaks from the liquid supply portion 218 due to the cartridge 20 falling or colliding with other objects and receiving an impact, the leaked ink can be absorbed by the liquid absorbing material 235. When the sheet 230 is peeled off from the accommodation bottom wall 223, it is possible to prevent the ink from scattering to the outside.

The circuit substrate 250 illustrated in FIG. 8 is disposed with a cartridge-side terminal 251 that comes into contact with the apparatus-side terminal portion 125 of the cartridge mounting portion 12 illustrated in FIG. 2. The circuit substrate 250 is provided at a corner portion, which is a portion where the accommodation front wall 221 and the accommodation bottom wall 223 illustrated in FIG. 5 intersect. The corner portion is a recessed portion that is recessed toward the inside of the accommodation portion 220.

### A2. Description of Mounting Process and Mounted State of Cartridge 20:

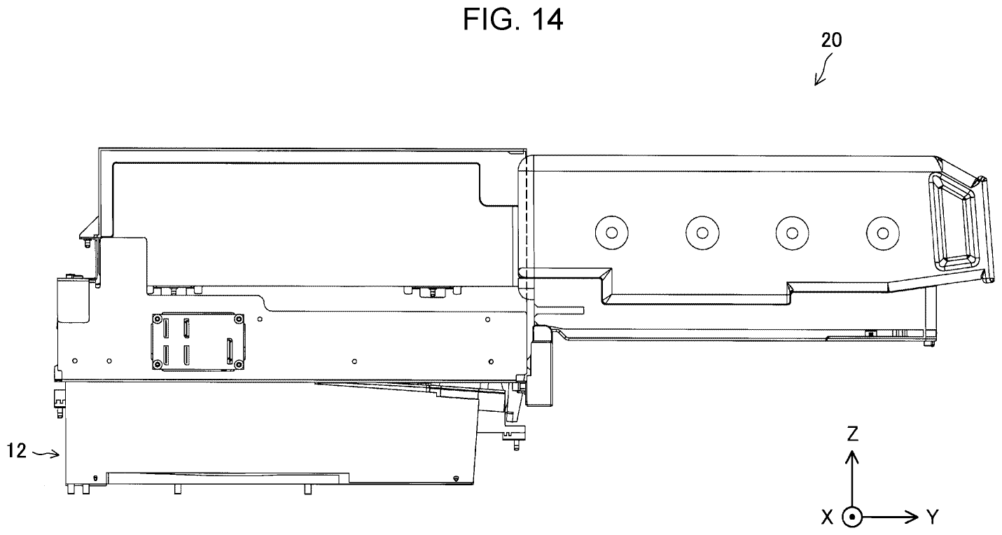

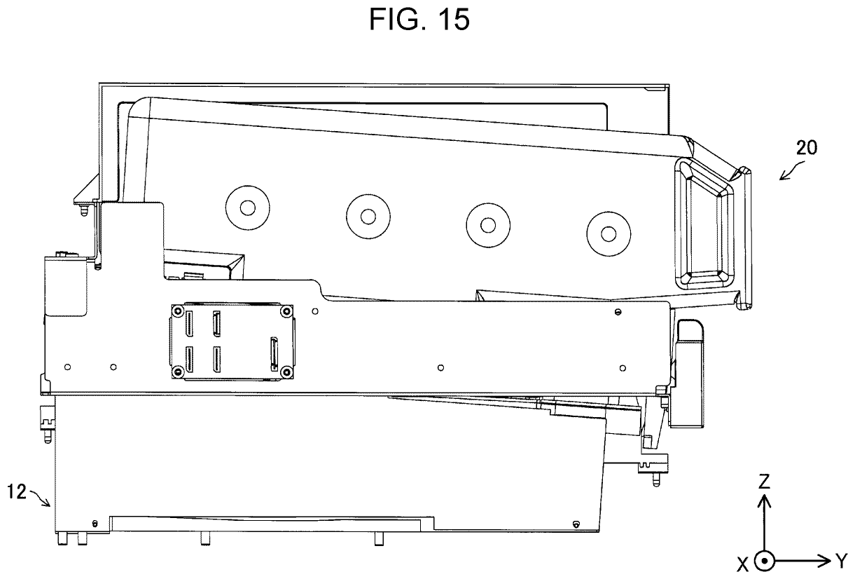

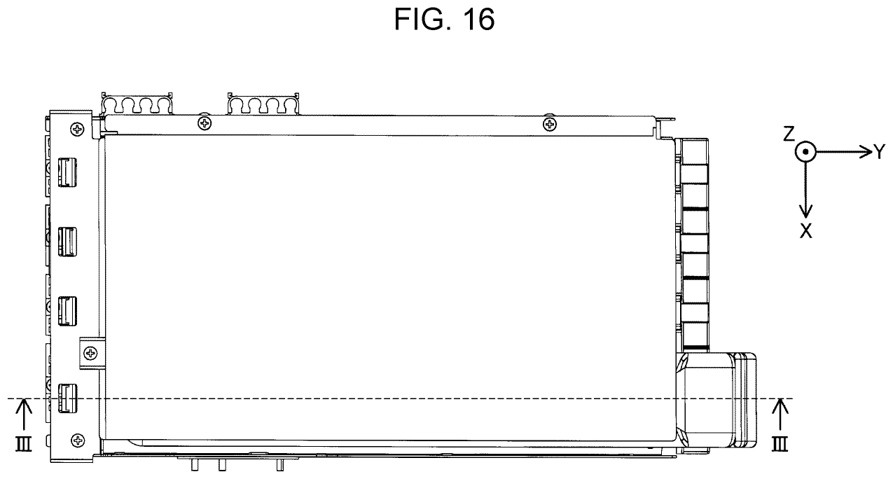

FIG. 14 is a view illustrating a mounting process, which is a process of mounting the cartridge 20 on the cartridge mounting portion 12. FIG. 15 is a view illustrating a mounted state where mounting of the cartridge 20 on the cartridge mounting portion 12 is completed. FIG. 16 is a view of FIG. 15 as viewed in the −Z direction. FIG. 3 described above is a cross-sectional view taken along line III-III in FIG. 16. First, the mounting process and the mounted state after the sheet 230 is peeled off from the accommodation bottom wall 223 will be described. The mounting process includes a terminal coupling process and a supply portion coupling process. The terminal coupling process is a process in which the cartridge 20 is moved in the −Y direction by the user from the state illustrated in FIG. 14 to the state illustrated in FIG. 7, and is inserted into the accommodation chamber 120a of the cartridge mounting portion 12 illustrated in FIG. 2, thereby electrically coupling the apparatus-side terminal portion 125 of the cartridge mounting portion 12 and the cartridge-side terminal 251 of the cartridge 20. The supply portion coupling process is a process in which the liquid introduction portion 121 of the cartridge mounting portion 12 and the liquid supply portion 218 of the cartridge 20 are coupled, in a state where the electrical coupling between the apparatus-side terminal portion 125 and the cartridge-side terminal 251 are coupled. Specifically, in the supply portion coupling process, the user rotationally moves the accommodation rear wall 222 of the cartridge 20 in a method indicated by an arrow A, around a rotation fulcrum RF of the cartridge mounting portion 12 illustrated in FIG. 3 from the state in FIG. 7, thereby coupling the liquid introduction portion 121 and the liquid supply portion 218. As a result, as illustrated in FIG. 15, the mounting of the cartridge 20 on the cartridge mounting portion 12 is completed. In the mounted state illustrated in FIG. 3, the cartridge engagement portion 222a of the cartridge 20 is engaged with the mounting engagement portion 126a formed in the engagement forming body 126 of the cartridge mounting portion 12, and thus, the mounted state is maintained.

A3. Description of Preventing Sheet 230 from Being Forgotten to Peel Off:

As described above, in the state where the sheet 230 is peeled off from the accommodation bottom wall 223, the cartridge 20 is smoothly mounted on the cartridge mounting portion 12. Hereinafter, a case where the mounting process is performed in a welded state where the sheet 230 is welded to the accommodation bottom wall 223 will be described. As described above, the first sheet side portion 231 of the sheet 230 in FIG. 8 is disposed so as to overlap the first cartridge guide portion 224a and be positioned on the −X direction side from the first cartridge guide portion 224a. In addition, the second sheet side portion 232 of the sheet 230 is disposed so as to overlap the second cartridge guide portion 225a and be positioned on the +X direction side from the second cartridge guide portion 225a. In the present embodiment, when the terminal coupling process of shifting from the state illustrated in FIG. 14 to the state illustrated in FIG. 7 is performed in the welded state, the sheet 230 is interposed between the first mounting guide portion 122ba and the first cartridge guide portion 224a, and between the second mounting guide portion 122ca and the second cartridge guide portion 225a. As a result, in the welded state, the cartridge 20 is not smoothly moved in the −Y direction when the terminal coupling process is performed. Therefore, the user can realize that the sheet 230 has been forgotten to be peeled off in the terminal coupling process, which is a stage before the sheet 230 collides with the liquid introduction portion 121. As a result, it is possible to prevent the sheet 230 from colliding with the liquid introduction portion 121 and the ink from adhering to the outer surface of the sheet 230.

In the welded state, when the supply portion coupling process that shifts from the state illustrated in FIG. 7 to the state illustrated in FIG. 15 is performed, at a stage before the coupling between the liquid introduction portion 121 of the cartridge mounting portion 12 and the liquid supply portion 218 of the cartridge 20 is started, the sheet 230 is interposed between the apparatus-side supply portion positioning portion 124 and the supply portion positioning portion 223b. In the present embodiment, the second welding projection portion 223ea is arranged along the outer edge of the supply portion positioning portion 223b. That is, the outer edge of the supply portion positioning portion 223b is welded to the sheet 230 by heat welding. When the cartridge 20 is rotationally moved in the direction of arrow A in FIG. 7 by the user, the apparatus-side supply portion positioning portion 124 collides with the sheet 230. Therefore, the smooth movement of the cartridge 20 in the direction of arrow A is not performed, and the user can realize that the sheet 230 has been forgotten to be peeled off. As a result, it is possible to prevent the sheet 230 from colliding with the liquid introduction portion 121 and the liquid from adhering to the sheet 230.

In addition, as described above, the first sheet end portion 233 of the sheet 230 in FIG. 8 projects outward from the accommodation rear wall 222 to the extent that the first sheet end portion 233 covers a portion of the cartridge engagement portion 222a. As illustrated in FIG. 8, the first sheet end portion 233 is positioned in the +Y direction from the accommodation rear wall 222 in the Y direction, which is the longitudinal direction of the cartridge 20. When the supply portion coupling process of shifting from the state illustrated in FIG. 7 to the state illustrated in FIG. 15 is performed, in the stage before the mounting is completed, the sheet 230 is interposed between the mounting engagement portion 126a of the cartridge mounting portion 12 and the cartridge engagement portion 222a of the cartridge 20 illustrated in FIG. 3. As a result, the mounting engagement portion 126a collides with the sheet 230, so that the smooth rotational movement of the cartridge 20 in the direction of arrow A is not performed, and the user can realize that the sheet 230 has been forgotten to be peeled off before the mounting of the cartridge 20 in the cartridge mounting portion 12 is completed. Therefore, it is possible to prevent the user from being forgotten to peel off the sheet 230. As a result, the liquid supply portion 218 and the liquid introduction portion 121 are normally coupled to each other.

According to the cartridge 20 of the present embodiment, the plurality of first heat welding portions 223d are attached to a portion of the surface of the first welding projection portion 223ca in a state of being spaced apart from each other. Therefore, when the sheet 230 is peeled off from the accommodation bottom wall 223 by the user, the shape of the first heat welding portion 223d that adheres to and peels off the sheet 230 is smaller than that in the case where the first heat welding portion 223d is continuous. Therefore, even when a portion of the first heat welding portion 223d that is peeled off from the accommodation bottom wall 223 enters the opening 223a, compared to an aspect in which the plurality of first heat welding portions 223d are continuous, the possibility that a gap is generated between the liquid introduction portion 121 of the printing apparatus 10 and the liquid supply portion 218 can be reduced. Furthermore, since the sheet 230 covers the opening 223a, it is possible to prevent foreign matter from entering the opening 223a.

In addition, the plurality of first coupling portions 223cb couple between the first welding projection portions 223ca in which the first heat welding portions 223d overlap, so that the first coupling portion 223cb can receive ink when the ink leaks from the opening 223a. In addition, since the first welding projection portion 223ca positioned at the vertices adjacent to each other of the first projection portion for welding 223c are welded to each other, and the first coupling portion 223cb between the first welding projection portions 223ca adjacent to each other is continuous contact with the sheet 230, the first coupling portion 223cb positioned between the vertices and the sheet 230 can be brought into close contact with each other. As a result, it is possible to prevent foreign matter from entering between the first coupling portion 223cb and the sheet 230.

When the sheet 230 is peeled off, the non-overlapping portion 223db illustrated in FIG. 13 adheres to the sheet 230 and may be peeled off from the accommodation bottom wall 223. According to the cartridge 20 of this aspect, among the angular range formed by a straight line parallel to the peeling direction and the straight line D1 perpendicular to the peeling direction, passing through the points defining the overlapping portion 223da and the non-overlapping portion 223 db, respectively, the portion where the non-overlapping portion 223db is positioned is smaller than 90°. That is, when viewed in the Z direction, which is the direction where the sheet 230 and the first heat welding portion 223d overlap each other, there is a portion where the first heat welding portion 223d is not positioned in the angular range formed by a straight line parallel to the −Y direction, which is the peeling direction, and the straight line D1 perpendicular to the peeling direction. When a force to peel off the sheet 230 is applied to a boundary between the portion and the non-overlapping portion 223 db, compared to an aspect in which the portion where the non-overlapping portion 223db is positioned is larger than 90°, the sheet 230 is unlikely to peel off while adhering to the non-overlapping portion 223 db. As a result, when the user peels the sheet 230 in the peeling direction, the portion of the heat welding portion that is likely to be peeled off and the sheet 230 can be easily separated.

### A4. Method of Heat Welding Sheet 230:

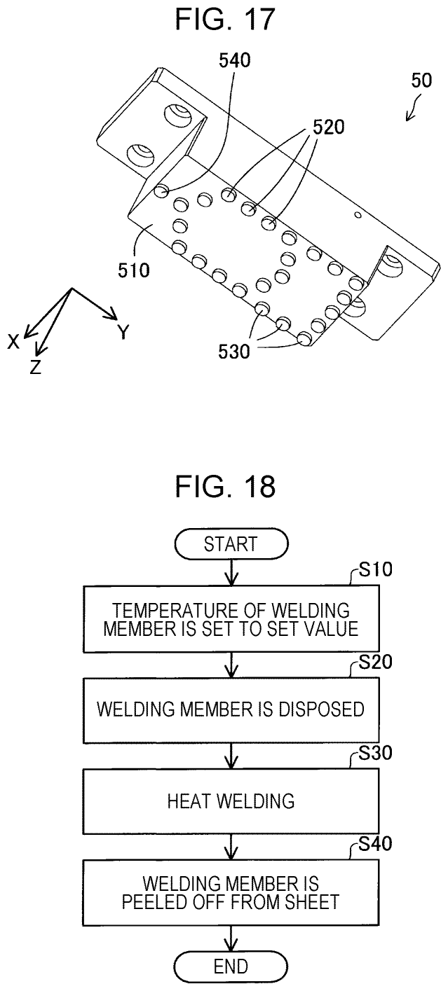

FIG. 17 is a diagram illustrating the first welding member 50. The first welding member 50 is a member used when the sheet 230 is heat-welded to the first attachment portion 30, the second attachment portion 31, and the third attachment portion 32 in FIG. 11. In FIG. 17, in order to describe the posture of the first welding member 50 in heat welding, the X direction, the Y direction, and the Z direction are illustrated. The heat welding is performed in a state where the X direction, the Y direction, and the Z direction in FIG. 17 coincide with the X direction, the Y direction, and the Z direction in FIG. 11. As illustrated in FIG. 17, the first welding member 50 has a substantially rectangular shape in appearance. The first welding member 50 can generate heat so as to have a surface temperature of 280° C. In the present embodiment, the first welding member 50 is a heater. The first welding member 50 has a first bottom surface 510. The first bottom surface 510 is a surface facing the accommodation bottom wall 223, which is the wall portion of the accommodation portion 220 in FIG. 11, at the time of heat welding. The first bottom surface 510 is provided with 14 first heating projection portions 520, nine second heating projection portions 530, and a third heating projection portion 540.

The first heating projection portion 520 heat-welds the first attachment portion 30 illustrated in FIG. 11 and the sheet 230. The sheet 230 is not illustrated in FIG. 11. The first heating projection portion 520 illustrated in FIG. 17 is a projection portion formed at the first bottom surface 510. The first heating projection portions 520 are formed at the first bottom surface 510 in a state of being spaced apart from each other. In the present embodiment, the fourteen first heating projection portions 520 are configured such that the contour has a substantially hexagonal shape when the first heating projection portions 520 adjacent to each other are coupled to each other by a line. Among the 14 first heating projection portions 520, six heating projection portions are positioned at the vertices of a substantial hexagon. The second heating projection portion 530 heat-welds the second attachment portion 31 and the sheet 230. The second heating projection portion 530 is a projection portion formed at the first bottom surface 510. The second heating projection portions 530 are formed at the first bottom surface 510 in a state of being spaced apart from each other. The third heating projection portion 540 heat-welds the third attachment portion 32 and the sheet 230. The third heating projection portion 540 is a projection portion formed at the first bottom surface 510. The third heating projection portion 540 is formed on the −Y direction side with respect to the first heating projection portion 520. The third heating projection portion 540 is formed at an interval from the first heating projection portion 520.

FIG. 18 is a flowchart illustrating an example of a method of heat welding the sheet 230. The heat welding may be performed by a worker or a robot for which a procedure is stored in advance. As a premise, the cartridge 20 illustrated in FIG. 6 before the sheet 230 is heat-welded is fixed to the jig in a state where the opening 223a, the first attachment portion 30, the supply portion positioning portion 223b, the second attachment portion 31, and the third attachment portion 32 are covered with the sheet 230. In Step S10 in FIG. 18, the temperature of the first welding member 50 is set to a set value. In the present embodiment, the temperature of the first welding member 50 is raised to 280° C. In step S20, the X-axis, the Y-axis, and the Z-axis in FIG. 17 coincide with the X-axis, the Y-axis, and the Z-axis in FIG. 6. Furthermore, when viewed in the Z direction, among the 14 first heating projection portions 520, the first welding member 50 is disposed such that the six first heating projection portions 520 positioned at the vertices of the substantially hexagonal shape described above overlap the hexagonal vertices of the first attachment portion 30. At this time, the first welding member 50 is disposed such that the third heating projection portion 540 and the end portion of the third attachment portion 32 on the −Y direction side overlap each other when viewed in the Z direction.

In Step S30 in FIG. 18, the first welding member 50 is moved in a welding direction, which is a direction where the sheet 230 and the first attachment portion 30 are heat-welded. The welding direction is the +Z direction. In a state where the first heating projection portion 520, the second heating projection portion 530, and the third heating projection portion 540 are in contact with the sheet 230, the first attachment portion 30, the second attachment portion 31, the third attachment portion 32, and the sheet 230 are heat-welded by the first welding member 50. The portion of the first bottom surface 510 where the first heating projection portion 520, the second heating projection portion 530, and the third heating projection portion 540 are not formed is welded so as not to be in contact with the sheet 230. In step S30, a portion of the first attachment portion 30, the second attachment portion 31, the third attachment portion 32, and the sheet 230 are melted by heat welding. In the present embodiment, when viewed in the Z direction, a portion of the first attachment portion 30 that overlaps the first heating projection portion 520, a portion of the second attachment portion 31 that overlaps the second heating projection portion 530, a portion of the third attachment portion 32 that overlaps the third heating projection portion 540 are melted. In the present embodiment, when viewed in the Z direction, a portion of the sheet 230 that overlaps the first attachment portion 30, the second attachment portion 31, and the third attachment portion 32 is also melted. In step S30, the temperature and the welding time of the first welding member are set so that the overlapping portions of the first attachment portion 30, the second attachment portion 31, and the third attachment portion 32 do not completely melt. In addition, the temperature and the welding time of the first welding member are set so that the portion of the sheet 230 that overlaps the first attachment portion 30, the second attachment portion 31, and the third attachment portion 32 does not completely melt. In Step S40 in FIG. 18, after a lapse of a predetermined time, the first welding member 50 is peeled off from the sheet 230. Thereafter, the processing ends.

By welding the melted portions of the first attachment portion 30 and the sheet 230 to each other, the first projection portion for welding 223c and the first heat welding portion 223d are formed. In the present embodiment, as illustrated in FIG. 10, the 14 first welding projection portions 223ca, the 14 first coupling portions 223cb, and the 14 first heat welding portions 223d are formed. As described above, the first welding projection portion 223ca is a portion that is not melted by heat welding of the first attachment portion 30. The 14 first welding projection portions 223ca are arranged along the outer edge of the opening 223a in a state of being spaced apart from each other. As described above, the first projection portion for welding 223c has a hexagonal shape when viewed in the +Z direction, and the first attachment portion 30 and the sheet 230 are heat-welded by the first heating projection portion 520 so that and each of the six first welding projection portions 223ca is disposed at each of the hexagonal vertices. The first heat welding portion 223d is a portion formed by melting by heat welding of the first attachment portion 30. The first heat welding portion 223d adheres to a portion of the surface of the first welding projection portion 223ca. Each of the first heat welding portions 223d is disposed in a state of being spaced apart. In the present embodiment, as described above, the first coupling portion 223cb couples the first welding projection portions 223ca adjacent to each other. By coupling the first coupling portion 223cb and the first welding projection portions 223ca, the first projection portion for welding 223c, which is one continuous projection portion, surrounding the opening 223a is formed.

Furthermore, in the present embodiment, as illustrated in FIG. 13, among the 14 first heat welding portions 223d, the first heat welding portion 223d positioned on the side of the hexagon is provided with the overlapping portion 223da that overlaps the first welding projection portion 223ca and the non-overlapping portion 223db that does not overlap the first welding projection portion 223ca when viewed in the +Z direction. The first heat welding portion 223d is formed so that the angle formed by the straight line D1 that passes through a first intersection FI with a line defining the overlapping portion 223da and the non-overlapping portion 223db and is perpendicular to the peeling direction, and the tangent T that passes through the end portion Ed when approaching the first intersection FI along the outer contour of the non-overlapping portion 223db of the outer periphery of the first heat welding portion 223d is 30°.

By welding the melted portions of the second attachment portion 31 and the sheet 230 to each other, the second projection portion for welding 223e and the second heat welding portion 223f are formed as illustrated in FIG. 10. In the present embodiment, nine second welding projection portions 223ea, eight second coupling portions 223eb, and eight second heat welding portions 223f are formed. As described above, the second welding projection portion 223ea is a portion that is not melted by heat welding of the second attachment portion 31. The second heat welding portion 223f is a portion formed by melting by heat welding of the second attachment portion 31. Each of the second heat welding portions 223f is attached to a portion of the surface of the second welding projection portion 223ea. Each of the second heat welding portions 223f is disposed in a state of being spaced apart. In the present embodiment, as described above, the second coupling portion 223eb couples the second welding projection portions 223ea adjacent to each other. By coupling the second coupling portion 223eb and the second welding projection portion 223ea to each other, the second projection portion for welding 223e, which is one continuous projection portion, is formed.

In addition, by welding the melted portions of the third attachment portion 32 and the sheet 230 to each other, the third welding projection portion 223gb and the third heat welding portion 223h are formed. In the present embodiment, the third welding projection portion 223gb, the third coupling portion 223ga, and the third heat welding portion 223h are formed.

In the method of heat welding of the present embodiment, each of the shapes of the plurality of first welding projection portions 223ca and the plurality of first heat welding portions 223d is based on the shape of the first heating projection portion 520. Therefore, the degree of freedom in the shape of the first attachment portion 30 is increased.

### B. Second Embodiment

### B1. Configuration of Second Embodiment

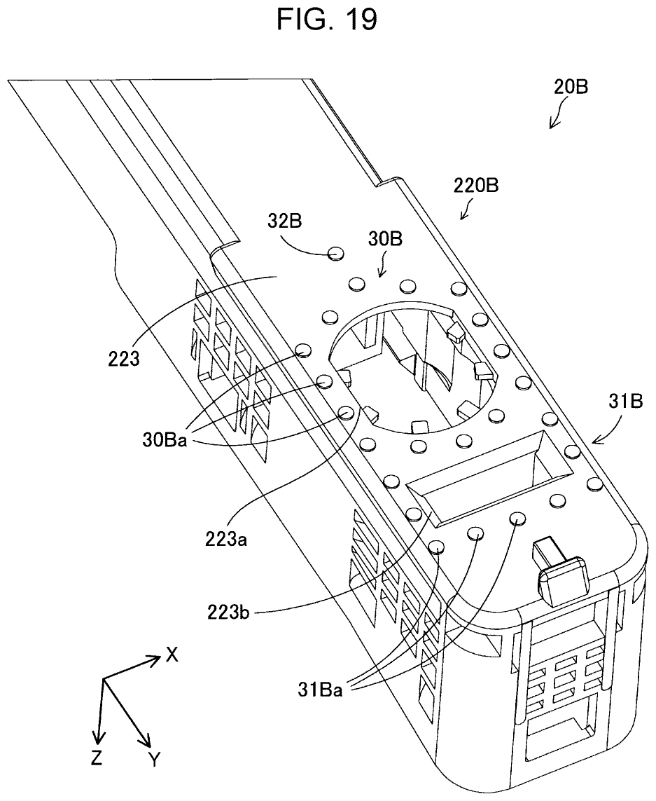

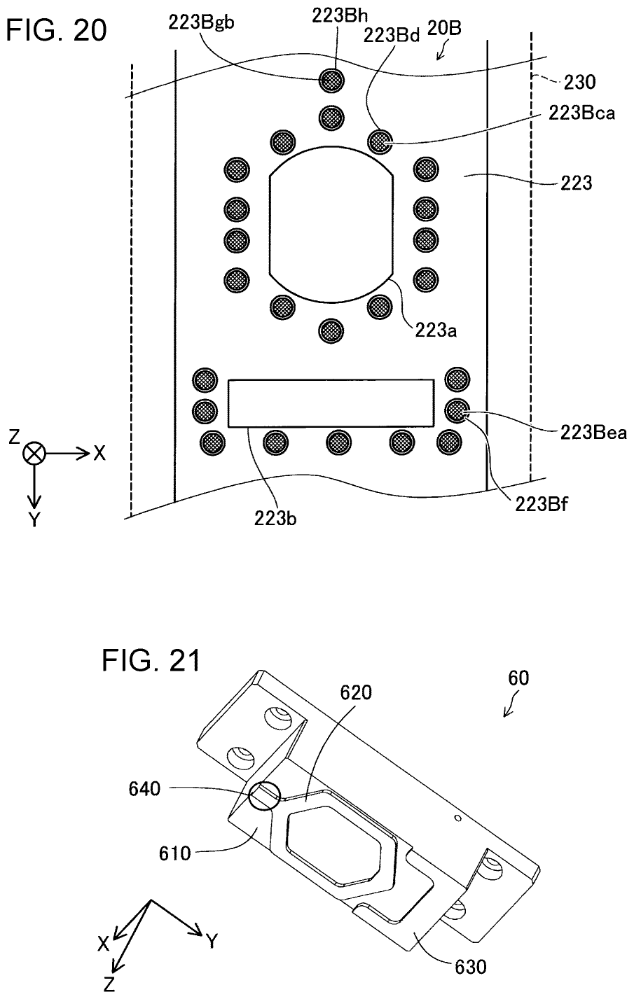

FIG. 19 is a view illustrating a cartridge 20B according to a second embodiment. FIG. 19 is an enlarged view of a portion of an accommodation portion 220B in the cartridge 20B in a state where the sheet 230 is not heat-welded. FIG. 20 is a diagram illustrating a cartridge 20B in a state where the sheet 230 is heat-welded. FIG. 20 corresponds to FIG. 10. FIG. 21 is a diagram illustrating a second welding member 60. As illustrated in FIGS. 19 to 21, in the second embodiment, the shapes of a first attachment portion 30B, a first welding projection portion 223Bca, a second attachment portion 31B, a second welding projection portion 223Bea, a third attachment portion 32B, a third welding projection portion 223Bgb, and a second welding member 60 are different from those in the first embodiment. In addition, in the second embodiment, the cartridge 20B is not provided with the first coupling portion 223cb, the second coupling portion 223eb, and the third coupling portion 223ga. Since the other configurations are the same as those of the first embodiment, the same reference numerals as those of the first embodiment will be given and detailed descriptions thereof will be omitted.

As illustrated in FIG. 20, the cartridge 20B of the second embodiment is provided with 14 first welding projection portions 223Bca, 14 first heat welding portions 223Bd, nine second welding projection portions 223Bea, nine second heat welding portion 223Bf, a third welding projection portion 223Bgb, and a third heat welding portion 223Bh.

Before describing the first welding projection portion 223Bca of the second embodiment, the cartridge 20B before being heat-welded will be described. As illustrated in FIG. 19, in a state before being heat-welded to the sheet 230, the cartridge 20B is provided with a first attachment portion 30B, a second attachment portion 31B, and a third attachment portion 32B. The first attachment portion 30B, the second attachment portion 31B, and the third attachment portion 32B are projection portions that are formed at the accommodation bottom wall 223 of the cartridge 20B before being heat-welded to the sheet 230. As illustrated in FIG. 19, the first attachment portion 30B, the second attachment portion 31B, and the third attachment portion 32B project from the accommodation bottom wall 223. The first attachment portion 30B, the second attachment portion 31B, and the third attachment portion 32B are made of a material that can be heat-welded. In the present embodiment, the first attachment portion 30B, the second attachment portion 31B, and the third attachment portion 32B are made of polypropylene. The first attachment portion 30B has 14 first circular portions 30Ba. The 14 first circular portions 30Ba are arranged along the outer edge of the opening 223a in a state of being spaced apart from each other. The first circular portion 30Ba has a circular shape when viewed in the Z direction. The second attachment portion 31B has nine second circular portions 31Ba. The nine second circular portions 31Ba are arranged along the edge of the supply portion positioning portion 223b other than the edge on the opening 223a side in a state of being spaced apart from each other. The third attachment portion 32B is positioned on the −Y direction side of the first attachment portion 30B. The third attachment portion 32B has a circular shape when viewed in the Z direction.

The first welding projection portion 223Bca illustrated in FIG. 20 is a portion that is not melted by heat welding of the first circular portion 30Ba, which is a projection portion before being heat-welded illustrated in FIG. 19. As illustrated in FIG. 20, the 14 first welding projection portions 223ca are arranged along the outer edge of the opening 223a in a state of being spaced apart from each other.

The first heat welding portion 223Bd is a portion formed by melting by heat welding of the first circular portion 30Ba of the first attachment portion 30B illustrated in FIG. 19. The first heat welding portion 223Bd illustrated in FIG. 20 is formed between the first welding projection portion 223Bca and the sheet 230. Each of the 14 first heat welding portions 223Bd is attached to a portion of the surface of the 14 first welding projection portions 223Bca. Although not illustrated, the first heat welding portion 223Bd is formed from the end portion of the first welding projection portion 223Bca on the −Z direction side over a portion of a stepped portion of the accommodation bottom wall 223 where the first projection portion for welding 223Bc is not formed. The portion of the first heat welding portion 223Bd formed in the stepped portion is a portion where the portion of the first attachment portion 30B melted by heat welding flows into the stepped portion and is solidified at the stepped portion. The first heat welding portion 223Bd covers an outer surface of the first welding projection portion 223Bca on the −Z direction side. When viewed in the +Z direction, each of the 14 first heat welding portions 223Bd overlaps so as to include one of the 14 first welding projection portions 223Bca. Each of the 14 first heat welding portions 223Bd is disposed in a state of being spaced apart.

The second welding projection portion 223Bea is a portion that is not melted by heat welding of the second circular portion 31Ba, which is a projection portion before being heat-welded as illustrated in FIG. 19. The nine second welding projection portions 223Bea illustrated in FIG. 20 are arranged along the outer edge of the supply portion positioning portion 223b other than the edge on the opening 223a side in a state of being spaced apart from each other.

The second heat welding portion 223Bf is a portion formed by melting by heat welding of the second circular portion 31Ba of the second attachment portion 31B illustrated in FIG. 19. The second heat welding portion 223Bf illustrated in FIG. 20 is formed between the second welding projection portion 223Bea and the sheet 230. Each of the nine second heat welding portions 223Bf adheres to a portion of the surface of the nine second welding projection portions 223Bea. Although not illustrated, the second heat welding portion 223Bf is formed from the end portion of the second welding projection portion 223Bea on the −Z direction side over a portion of the stepped portion of the accommodation bottom wall 223 where the second projection portion for welding 223Be is not formed. The portion of the second heat welding portion 223Bf formed in the stepped portion is a portion in which the portion of the second projection portion for welding 223Be melted by heat welding flows into the stepped portion and is solidified at the stepped portion. The second heat welding portion 223Bf covers an outer surface of the second welding projection portion 223Bea on the −Z direction side. When viewed in the +Z direction, each of the nine second heat welding portions 223Bf overlaps so as to include one of the nine second welding projection portions 223Bea. Each of the nine second heat welding portions 223Bf is disposed in a state of being spaced apart.

The third welding projection portion 223Bgb is a portion that is not melted by heat welding of the third circular portion of the third attachment portion 32B. The third heat welding portion 223Bh is a portion formed by melting by heat welding of the third circular portion illustrated in FIG. 19. As illustrated in FIG. 20, the third heat welding portion 223Bh adheres to the surface of the third welding projection portion 223Bgb.

### B2. Method of Heat Welding Sheet 230

In FIG. 21, in order to describe the posture of the second welding member 60 in heat welding, the X direction, the Y direction, and the Z direction are illustrated. The heat welding is performed in a state where the X direction, the Y direction, and the Z direction in FIG. 21 coincide with the X direction, the Y direction, and the Z direction in FIG. 19. As illustrated in FIG. 21, the second welding member 60 has a substantially rectangular shape in appearance. The second welding member 60 can generate heat so as to have a surface temperature of 280° C. In the present embodiment, the second welding member 60 is a heater. The second welding member 60 has a second bottom surface 610. The second bottom surface 610 is a surface facing the accommodation bottom wall 223, which is the wall portion of the accommodation portion 220, at the time of heat welding. The second bottom surface 610 is provided with a first heating projection portion 620, a second heating projection portion 630, and a third heating projection portion 640.

The first heating projection portion 620 heat-welds the first attachment portion 30B and the sheet 230. The first heating projection portion 620 is a projection portion formed at the second bottom surface 610. The first heating projection portion 620 is one continuous projection portion. In the present embodiment, the first heating projection portion 620 is configured such that the contour has a hexagonal shape when viewed in the Z direction. The second heating projection portion 630 heat-welds the second attachment portion 31B and the sheet 230. The second heating projection portion 630 is a projection portion formed at the second bottom surface 610. The second heating projection portion 630 is one continuous projection portion. The third heating projection portion 640 heat-welds the third attachment portion 32B and the sheet 230. The third heating projection portion 640 is a projection portion formed at the second bottom surface 610. The third heating projection portion 640 is coupled to the end portion of the first heating projection portion 620 on the −Y direction side.

The order of the method of heat welding the sheet 230 of the second embodiment is the same as the method of heat welding the sheet 230 of the first embodiment. Hereinafter, points different from those of the first embodiment will be described. In step S20 in FIG. 18, the X-axis, the Y-axis, and the Z-axis in FIG. 19 coincide with the X-axis, the Y-axis, and the Z-axis in FIG. 21, and the second welding member 60 is disposed so that the second bottom surface 610 and the accommodation bottom wall 223 face each other. In this state, the second welding member 60 is moved in the +Z direction, which is the welding direction, to perform welding. In the second embodiment, in the stage of step S20, the first heating projection portion 620 surrounds the opening 223a of the accommodation bottom wall 223 when viewed in the +Z direction. Furthermore, when viewed in the +Z direction, the sheet 230 and the first attachment portion 30B are heat-welded in a state where a portion of the first heating projection portion 620 overlaps so as to include the first attachment portion 30B. In addition, in the stage of Step S20, when viewed in the +Z direction, the second heating projection portion 530 is along the edge of the supply portion positioning portion 223b of the accommodation bottom wall 223 other than the edge on the opening 223a side. When viewed in the +Z direction, a portion of the second heating projection portion 630 heat-welds the sheet 230 and the second attachment portion 31B in a state of overlapping so as to include the second attachment portion 31B. Furthermore, when viewed in the +Z direction, the sheet 230 and the third attachment portion 32B are heat-welded in a state where a portion of the third heating projection portion 640 overlaps so as to include the third attachment portion 32B.

The plurality of first heat welding portions 223Bd adhere to a portion of the surface of the first welding projection portion 223Bca in a state of being spaced apart from each other. Therefore, when the sheet 230 is peeled off from the accommodation bottom wall 223 by the user, the shape of the first heat welding portion 223Bd that adheres to and peels off the sheet 230 is smaller than that in the case where the plurality of first heat welding portions are continuous. Therefore, even when a portion of the first heat welding portion 223Bd that is peeled off from the accommodation bottom wall 223 enters the opening 223a, compared to an aspect in which the first heat welding portions 223Bd are continuous, the possibility that a gap is generated between the liquid introduction portion 121 of the printing apparatus 10 and the liquid supply portion 218 can be reduced. Furthermore, since the sheet 230 covers the opening 223a, it is possible to prevent foreign matter from entering the opening 223a.

When the first welding projection portion 223ca, the second welding projection portion 223ea, and the third welding projection portion 223gb are not distinguished, these are referred to as the “welding projection portion”. When the first heat welding portion 223d, the second heat welding portion 223f, and the third heat welding portion 223h are not distinguished, these are referred to as the “heat welding portion”. When the first attachment portion 30, the second attachment portion 31, and the third attachment portion 32 are not distinguished, these are referred to as the “attachment portion”.

### C. Other Embodiments

### C1. Another Embodiment 1

(1) In the above embodiment, the liquid accommodation portion 217 and the accommodation portion 220 are molded by injection molding in which the polypropylene material is used, and the sheet 230 is made of polyethylene terephthalate. The liquid accommodation portion and the accommodation portion may be made of different materials, and the sheet may be made of polypropylene. The sheet is made of a material having a melting point higher than that of the material forming the accommodation portion.

(2) In the above embodiments, the dimension of the sheet 230 in the X direction is larger than an interval between the first cartridge guide portion 224a and the second cartridge guide portion 225a in the X direction. For example, the sheet may be positioned outside any one of the first cartridge guide portion and the second cartridge guide portion in the X direction, which is the lateral direction of the cartridge. Even in this manner, in the mounting process, since the sheet is disposed at a position interposed between the first mounting guide portion and the first cartridge guide portion or between the second mounting guide portion and the second cartridge guide portion, the mounting operation of the cartridge on the cartridge mounting portion cannot be smoothly performed by the sheet. As a result, the user can realize that the sheet has been forgotten to be peeled off before the mounting of the cartridge on the cartridge mounting portion is completed.

(3) In the above embodiment, the sheet 230 is partially formed with a fold along the X direction, which is the width direction. The sheet may not have a fold and may have a planar shape.

(4) In the above embodiment, the number of the first welding projection portions 223ca and the first heat welding portions 223d is 14, and the number of the second welding projection portions 223ea and the second heat welding portions 223f is nine. For example, the number of the first welding projection portions and the first heat welding portions may be other than 14, such as five or 20, and the number of the second welding projection portions and the second heat welding portions may be other than nine, such as five or ten. Each of the number of the first welding projection portions and the number of the first heat welding portions is the same, and each of the number of the second welding projection portions and the second heat welding portions is the same.

(5) In the first embodiment described above, the cartridge 20 before being heat-welded to the sheet 230 is provided with the second attachment portion 31 and the third attachment portion 32, and the second projection portion for welding 223e, the second heat welding portion 223f, the third projection portion for welding 223g, and the third heat welding portion 223h are formed by heat welding. For example, the cartridge before being heat-welded to the sheet need not be provided with at least one of the second attachment portion and the third attachment portion.

(6) In the above embodiments, when viewed in the +Z direction, each of the heat welding portions overlaps so as to include one of the welding projection portions. For example, in an aspect in which a hole is formed at the center of the first heating projection portion of the first welding member, each of the heat welding portions need not include all of the welding projection portions when viewed in the Z direction. When viewed in the +Z direction, each of the heat welding portions may overlap at least a portion of the welding projection portion. The heat welding portion is attached to at least a portion of the surface facing the sheet of the welding projection portion.

(7) In the above embodiment, the sheet 230 is bonded to the first welding projection portion 223ca, the second welding projection portion 223ea, and the third welding projection portion 223gb via the first heat welding portion 223d, the second heat welding portion 223f, and the third heat welding portion 223h. For example, in an aspect in which each of the heat welding portions does not include all of the welding projection portion when viewed in the Z direction, the sheet and a portion of the welding projection portion may be directly bonded to each other.

(8) In the above embodiment, when the supply portion coupling process is performed, at a stage before the coupling between the liquid introduction portion 121 of the cartridge mounting portion 12 and the liquid supply portion 218 of the cartridge 20 is started, the sheet 230 is interposed between the apparatus-side supply portion positioning portion 124 and the supply portion positioning portion 223b. For example, in an aspect in which the printing apparatus is not provided with the first mounting guide portion 122ba and the second mounting guide portion 122ca, the sheet need not be interposed between the apparatus-side supply portion positioning portion and the supply portion positioning portion.

(9) In the above embodiment, when the supply portion coupling process is performed, at a stage before the coupling between the liquid introduction portion 121 of the cartridge mounting portion 12 and the liquid supply portion 218 of the cartridge 20 is started, the sheet 230 is interposed between the apparatus-side supply portion positioning portion 124 and the supply portion positioning portion 223b. For example, in an aspect in which the dimension of the sheet in the Y direction is smaller than that of the first embodiment, the sheet need not be interposed between the apparatus-side supply portion positioning portion and the supply portion positioning portion.

(10) In the above embodiment, the first sheet end portion 233 of the sheet 230 projects outward from the accommodation rear wall 222 to the extent that the first sheet end portion 233 covers a portion of the cartridge engagement portion 222a. For example, the first sheet end portion of the sheet need not cover a portion of the cartridge engagement portion.

### C2. Another Embodiment 2

(1) In the first embodiment described above, the first coupling portion 223cb couples the first welding projection portions 223ca adjacent to each other. In addition, the second coupling portion 223eb couples the second welding projection portions adjacent to each other, and the third coupling portion 223GA couples the third welding projection portion 223gb and the first welding projection portion 223ca. For example, the first coupling portion may be coupled to any one of the first welding projection portions adjacent to each other, or may be disposed between the first welding projection portions adjacent to each other without coupling to the first welding projection portions adjacent to each other. In addition, the second coupling portion may be coupled to any one of the second welding projection portions adjacent to each other, or may be disposed between the second welding projection portions adjacent to each other without coupling to the second welding projection portions adjacent to each other. The third coupling portion may be coupled to any one of the third welding projection portion and the first welding projection portion, or need not be coupled.

(2) For example, the cartridge may include one or two of the first coupling portion, the second coupling portion, and the third coupling portion. The cartridge need not include a plurality of coupling portions.

### C3. Another Embodiment 3

(1) In the above embodiment, when viewed in the Z direction, which is the direction where the sheet and the first heat welding portion 223d overlap, the first projection portion for welding 223c has a hexagonal shape. For example, when viewed in the Z direction, the first projection portion for welding may have a polygonal shape other than a hexagon, such as a quadrangle or an octagon, or may have a circular shape. In the present specification, the fact that one continuous projection portion has a polygonal shape when viewed in a direction where the sheet and the heat welding portion overlap each other means that the contour has a polygonal shape when the contour passing through the end portion of the continuous projection portion opposite to the end portion in contact with the heat welding portion is viewed in the direction where the sheet and the heat welding portion overlap. In FIG. 12, the contour of the first welding projection portion 223ca passing through the end portion 70 has a hexagonal shape.

(2) In the above embodiment, when viewed in the Z direction, the second projection portion for welding 223e is along the edge of the supply portion positioning portion 223b other than the edge on the opening 223a side. For example, when viewed in the Z direction, the second welding projection portion may be one continuous projection portion that surrounds the supply portion positioning portion.

(3) In the above embodiments, the six first welding projection portions, which are a portion of the 14 first welding projection portions, are disposed at each of the vertices of the hexagon. For example, the first welding projection portion may be disposed at a portion of the vertices of the hexagon. In the aspect in which the cartridge is provided with the six first welding projection portions, all of the first welding projection portions may be disposed at each of the vertices of the hexagon. In addition, for example, all of the first welding projection portions may be disposed in the sides of the polygon.

### C4. Another Embodiment 4

(1) In the above embodiment, the first heat welding portion 223d positioned on the sides of the hexagon among the first heat welding portions 223d has a substantially elliptical shape when viewed in the Z direction. The first heat welding portions positioned on the sides of the hexagon among the first heat welding portions may have a quadrangular shape, a triangular shape, or a circular shape when viewed in the Z direction. The heat welding portion need not be shaped so that the angle formed by the straight line that passes through the intersection and perpendicular to the Y direction, which is the direction where the sheet is peeled off, and a tangent that passes through the end portion when approaching the intersection along the outer contour of the non-overlapping portion is an acute angle.

(2) In the above embodiment, the angle formed by the straight line D1 that passes through the first intersection FI and perpendicular to the −Y direction, which is the direction where the sheet 230 is peeled off, and the tangent T that passes through the end portion Ed when approaching the first intersection FI along the outer contour of the outer periphery of the non-overlapping portion 223db is 30°, which is an acute angle. For example, the angle formed by the straight line that passes through the intersection and perpendicular to the −Y direction, which is the direction where the sheet is peeled off, and a tangent that passes through the end portion when approaching the intersection along the outer contour of the outer periphery of the non-overlapping portion may be 15°, 45°, or 60°.

### C5. Another Embodiment 5

In the above embodiments, the first welding member 50 and the second welding member 60 can generate heat so that the surface temperature is 280° C. The first welding member and the second welding member may be configured so as to have a surface temperature of 200° C. or 300° C. The surface temperatures of the first welding member and the second welding member may be changed according to the combination of the material forming the accommodation portion and the material forming the sheet. By changing the temperature of the first welding member and the time for heat welding between the sheet and the attachment portion, the shapes and ratios of the formed welding projection portion and the heat welding portion may differ. The sheet and the attachment portion may be heat-welded at a temperature at which the material forming the sheet is not melted and the attachment portion is melted by the first welding member. In this aspect, the sheet and the welding projection portion are bonded via the heat welding portion by adhering the heat welding portion and the sheet to each other.

### C6. Another Embodiment 6

(1) In the first embodiment described above, the first welding member 50 is provided with the first heating projection portion 520, the second heating projection portion 530, and the third heating projection portion 540 on the first bottom surface 510. The first welding member need not include the second heating projection portion and the third heating projection portion in an aspect in which the cartridge does not include the second attachment portion and the third attachment portion. In addition, the first welding member need not include the second heating projection portion and the third heating projection portion in an aspect in which the cartridge includes the second attachment portion and the third attachment portion.

(2) In the first embodiment described above, the first welding member 50 is provided with a plurality of heating projection portions. For example, the first welding member may include six first heating projection portions. In this aspect, six first welding projection portions and six first heat welding portions are formed.

### C7. Another Embodiment 7

In the above embodiment, the sheet 230 and the first attachment portion 30 are heat-welded by the first welding member 50 such that at least a portion of the first welding projection portion 223ca is disposed at each of the vertices of the polygon. For example, in an aspect in which the first heating projection portion of the first welding member is welded in a state of overlapping the side of the first attachment portion when viewed in the +Z direction, the sheet and the first attachment portion may be heat-welded so that all of the first welding projection portions are disposed on the sides of the polygon.

### C8. Another Embodiment 8

In the first embodiment described above, the first heat welding portion 223d has a substantially elliptical shape when viewed in the Z direction. For example, in an aspect in which the first heating projection portion of the first welding member has a square shape when viewed in the Z direction, the formed first heat welding portion may be substantially a quadrangular shape.

### C9. Another Embodiment 9

In the second embodiment described above, the first heating projection portion 620, the second heating projection portion 630, and the third heating projection portion 640 of the second welding member 60 overlap each other so as to include the attachment portion. The first heating projection portion, the second heating projection portion, and the third heating projection portion of the second heating member may overlap a portion of the attachment portion when viewed in the +Z direction in a state of facing the accommodation bottom wall. The sheet and the accommodation bottom wall are firmly welded to each other as compared with the aspect in which a portion of the attachment portion overlaps.

### D. Other Aspects

The present disclosure is not limited to the above-described embodiments and can be implemented with various aspects without departing from the spirit thereof. For example, the present disclosure can also be realized by the following aspects. For example, the technical features in the above-described embodiments corresponding to the technical features in each aspect described below are to solve some or all of the above-described problems of the present disclosure, or in order to achieve some or all of the above-described effects of the present disclosure, replacement or combination thereof can be performed as appropriate. In addition, unless the technical features are described as essential in the present specification, deletion is possible as appropriate.

(1) According to an aspect of the present disclosure, there is provided a cartridge mounted on a printing apparatus including a liquid introduction portion. The cartridge includes a liquid accommodation portion that accommodates a liquid, a liquid supply portion configured to supply the liquid accommodated in the liquid accommodation portion to the printing apparatus by being coupled to the liquid introduction portion, an accommodation portion that accommodates a portion of the liquid supply portion therein, and includes a wall portion having an opening into which the liquid introduction portion is inserted and coupled to the liquid supply portion, a plurality of welding projection portions, which are a plurality of projection portions arranged along an outer edge of the opening in a state of being spaced apart, and a plurality of heat welding portions attached to a portion of a surface of the plurality of welding projection portions, and disposed in a state of being spaced apart, and a sheet bonded to the plurality of welding projection portions configured to be peeled off, while covering the opening, the plurality of welding projection portions, and the plurality of heat welding portions, in which the plurality of welding projection portions are projection portions before being heat-welded to the sheet formed at the wall portion, and are portions not melted by heat welding among projection portions made of a material configured to be heat-welded, and the plurality of heat welding portions are portions formed by being melted by heat welding among the projection portions before being heat-welded to the sheet, and a portion of which are in contact with the sheet.

According to the cartridge of this aspect, the plurality of heat welding portions adhere to a portion of the surface of the welding projection portion in a state of being spaced apart from each other. Therefore, when the sheet is peeled off from the wall portion by the user, the shape of the heat welding portion that adheres to and peels off the sheet is smaller than that in the aspect in which the heat welding portion is continuous. Therefore, even when a portion of the heat welding portion peeled off from the wall portion enters the opening, compared to an aspect in which the plurality of heat welding portions are continuous with each other, the possibility that a gap is generated between the liquid introduction portion of the printing apparatus and the liquid supply portion can be reduced. Furthermore, since the sheet covers the opening, it is possible to prevent foreign matter from entering the opening.

(2) In the cartridge of the above-described aspect, the wall portion further may have a plurality of coupling portions that couple the adjacent welding projection portions among the plurality of welding projection portions, and the plurality of welding projection portions and the plurality of coupling portions may constitute one continuous projection portion surrounding the opening.

According to the cartridge of this aspect, the plurality of coupling portions are coupled between the welding projection portions in which the heat welding portions overlap, so that the coupling portion can receive ink when the ink leaks from the opening.

(3) In the cartridge of the above-described aspect, the one continuous projection portion may have a polygonal shape when viewed in a direction where the sheet and the heat welding portion overlap, and at least a portion of the plurality of welding projection portions may be disposed at a vertex of the polygon, and the plurality of coupling portions may be continuously in contact with the sheet between the adjacent welding projection portions.

According to the cartridge of this aspect, since the coupling portion positioned between the adjacent welding projection portions is continuously in contact with the sheet, the coupling portion positioned between the vertices and the sheet are in close contact with each other. As a result, it is possible to prevent foreign matter from entering between the coupling portion and the sheet.

(4) In the cartridge of the above aspect, when viewed in a direction where the sheet and the heat welding portion overlap, the heat welding portion positioned on a side of the polygon among the plurality of heat welding portions may include an overlapping portion overlapping the welding projection portion, and a non-overlapping portion not overlapping the welding projection portion, and may be configured so that an angle formed by a straight line that passes through an intersection positioned closest to a front and perpendicular to a direction where the sheet is peeled off and a tangent that passes through an end portion when approaching the intersection along an outer contour of an outer periphery of the non-overlapping portion is an acute angle, when viewed along a direction where the sheet is peeled off, among intersections with a line defining the overlapping portion and the non-overlapping portion on an outer periphery of the heat welding portion.

The non-overlapping portion may adhere to the sheet and be peeled off from the wall portion when the sheet is peeled off. According to the cartridge of this aspect, among the angular range formed by a straight line parallel to the peeling direction and a straight line perpendicular to the peeling direction, that pass through each of the points defining the overlapping portion and the non-overlapping portion, the portion where the non-overlapping portion is positioned is smaller than 90°. That is, when viewed in the direction where the sheet and the heat welding portion overlap, there is a portion where the heat welding portion is not positioned in the angular range formed by a straight line parallel to the peeling direction and the straight line perpendicular to the peeling direction. When a force to peel off the sheet is applied to a boundary between the portion and the non-overlapping portion, compared to an aspect in which the portion where the non-overlapping portion is positioned is larger than 90°, the sheet is unlikely to peel off while adhering to the non-overlapping portion. As a result, when the user peels the sheet in the peeling direction, the portion of heat welding portion which is likely to be peeled off, and the sheet can be easily separated.

(5) According to another aspect of the present disclosure, there is provided a method of heat welding a sheet. The method of heat welding a sheet includes forming a plurality of welding projection portions, which are portions not melted by heat welding of an attachment portion, which is a projection portion made of a material configured to be heat-welded, and a plurality of projection portions arranged along an outer edge of an opening, which is formed at a wall portion of an accommodation portion that accommodates a portion of a liquid supply portion configured to cause a liquid accommodated in a liquid accommodation portion to flow out to a printing apparatus therein, in a state of being spaced apart, and a plurality of heat welding portions formed by melting by heat welding and are attached to a portion of a surface of the plurality of welding projection portions among the attachment portion, and are disposed in a state of being spaced apart, by heat-welding the attachment portion and a sheet made of a material configured to be heat-welded, by using a welding member, in a state where the opening and the attachment portion are covered with the sheet.

(6) According to the method of heat welding a sheet of the aspect, the welding member may include a surface that faces the wall portion during heat welding, the surface may include a plurality of heating projection portions which are a plurality of projection portions and are formed in a state of being spaced apart, the attachment portion may be one continuous projection portion that surrounds the opening, and the plurality of welding projection portions and the plurality of heat welding portions may be formed by heat-welding the sheet and the attachment portion in a state where the plurality of heating projection portions are in contact with the sheet.

In the method of heat welding the sheet of the aspect, each of the shapes of the plurality of welding projection portions and the plurality of heat welding portions is based on the shape of the heating projection portion. Therefore, the degree of freedom in the shape of the attachment portion is increased.

(7) According to the method of heat welding a sheet of the aspect, the one continuous projection portion may have a polygonal shape when viewed in a welding direction, which is a direction where the sheet and the attachment portion are heat-welded, and the attachment portion and the sheet may be heat-welded by the plurality of heating projection portions so that at least a portion of the plurality of welding projection portions is disposed at a vertex of the polygon.

(8) According to the method of heat welding a sheet of the aspect, when viewed in the welding direction, the heat welding portion positioned on a side of the polygon among the plurality of heat welding portions may include an overlapping portion that overlaps the welding projection portion and a non-overlapping portion that does not overlap the welding projection portion, and may be formed so that an angle formed by a straight line that passes through an intersection with a line defining the overlapping portion and the non-overlapping portion, and perpendicular to a peeling direction, and a tangent that passes through an end portion when approaching the intersection along an outer contour of an outer periphery of the non-overlapping portion among an outer periphery of the heat welding portion is an acute angle.

(9) According to the method of heat welding a sheet of the above aspect, the attachment portion may be a plurality of projection portions arranged along an outer edge of the opening in a state of being spaced apart, the welding member may include a surface that faces the wall portion during heat welding, and the surface may include a heating projection portion that projects from the surface, surround the opening, when viewed in a welding direction, which is a direction where the sheet and the attachment portion are heat-welded, in a state where the surface faces the wall portion, and partially overlap to include the attachment portion.

What is claimed is:

1. A cartridge mounted on a printing apparatus having a liquid introduction portion, the cartridge comprising:
a liquid accommodation portion that accommodates a liquid;
a liquid supply portion configured to supply the liquid accommodated in the liquid accommodation portion to the printing apparatus by being coupled to the liquid introduction portion;
an accommodation portion that accommodates a portion of the liquid supply portion therein, and includes a wall portion having
an opening into which the liquid introduction portion is inserted and coupled to the liquid supply portion,
a plurality of welding projection portions, which are a plurality of projection portions arranged along an outer edge of the opening in a state of being spaced apart, and
a plurality of heat welding portions attached to a portion of a surface of the plurality of welding projection portions, and disposed in a state of being spaced apart; and
a sheet bonded to the plurality of welding projection portions configured to be peeled off, while covering the opening, the plurality of welding projection portions, and the plurality of heat welding portions, wherein
the plurality of welding projection portions are projection portions before being heat-welded to the sheet formed at the wall portion, and are portions not melted by heat welding among projection portions made of a material configured to be heat-welded, and
the plurality of heat welding portions are portions formed by being melted by heat welding among the projection portions before being heat-welded to the sheet, and a portion of which are in contact with the sheet.

2. The cartridge according to claim 1, wherein
the wall portion further has a plurality of coupling portions that couple the adjacent welding projection portions adjacent among the plurality of welding projection portions, and
the plurality of welding projection portions and the plurality of coupling portions constitute one continuous projection portion surrounding the opening.

3. The cartridge according to claim 2, wherein
the one continuous projection portion has a polygonal shape when viewed in a direction where the sheet and the heat welding portion overlap, and at least a portion of the plurality of welding projection portions is disposed at a vertex of the polygon, and
the plurality of coupling portions are continuously in contact with the sheet between the adjacent welding projection portions.

4. The cartridge according to claim 3, wherein
when viewed in a direction where the sheet and the heat welding portion overlap, the heat welding portion positioned on a side of the polygon among the plurality of heat welding portions includes an overlapping portion overlapping the welding projection portion, and a non-overlapping portion not overlapping the welding projection portion, and is configured so that an angle formed by a straight line that passes through an intersection positioned closest to a front and perpendicular to a direction where the sheet is peeled off and a tangent that passes through an end portion when approaching the intersection along an outer contour of an outer periphery of the non-overlapping portion is an acute angle, when viewed along a direction where the sheet is peeled off, among intersections with a line defining the overlapping portion and the non-overlapping portion on an outer periphery of the heat welding portion.

5. A method of heat welding a sheet, comprising:
forming a plurality of welding projection portions, which are portions not melted by heat welding of an attachment portion, which is a projection portion made of a material configured to be heat-welded, and a plurality of projection portions arranged along an outer edge of an opening, which is formed at a wall portion of an accommodation portion that accommodates a portion of a liquid supply portion configured to cause a liquid accommodated in a liquid accommodation portion to flow out to a printing apparatus therein, in a state of being spaced apart, and
a plurality of heat welding portions formed by melting by heat welding and are attached to a portion of a surface of the plurality of welding projection portions among the attachment portion, and are disposed in a state of being spaced apart,
by heat-welding the attachment portion and a sheet made of a material configured to be heat-welded, by using a welding member,
in a state where the opening and the attachment portion are covered with the sheet.

6. The method of heat welding a sheet according to claim 5, wherein
the welding member includes a surface that faces the wall portion during heat welding,
the surface includes a plurality of heating projection portions which are a plurality of projection portions and are formed in a state of being spaced apart,
the attachment portion is one continuous projection portion that surrounds the opening, and
the plurality of welding projection portions and the plurality of heat welding portions are formed by heat-welding the sheet and the attachment portion in a state where the plurality of heating projection portions are in contact with the sheet.

7. The method of heat welding a sheet according to claim 6, wherein
the one continuous projection portion has a polygonal shape when viewed in a welding direction, which is a direction where the sheet and the attachment portion are heat-welded, and
the attachment portion and the sheet are heat-welded by the plurality of heating projection portions so that at least a portion of the plurality of welding projection portions is disposed at a vertex of the polygon.

8. The method of heat welding a sheet according to claim 7, wherein
when viewed in the welding direction, the heat welding portion positioned on a side of the polygon among the plurality of heat welding portions includes an overlapping portion that overlaps the welding projection portion and a non-overlapping portion that does not overlap the welding projection portion, and is formed so that an angle formed by a straight line that passes through an intersection with a line defining the overlapping portion and the non-overlapping portion, and perpendicular to a peeling direction, and a tangent that passes through an end portion when approaching the intersection along an outer contour of an outer periphery of the non-overlapping portion among an outer periphery of the heat welding portion is an acute angle.

9. The method of heat welding a sheet according to claim 5, wherein
the attachment portion is a plurality of projection portions arranged along an outer edge of the opening in a state of being spaced apart,
the welding member includes a surface that faces the wall portion during heat welding, and
the surface includes a heating projection portion that projects from the surface, surrounds the opening, when viewed in a welding direction, which is a direction where the sheet and the attachment portion are heat-welded, in a state where the surface faces the wall portion, and partially overlaps to include the attachment portion.
